(19) United States
(12) Patent Application Publication
(10) Pub. No.: US 2026/0281028 A1
(43) Pub. Date: Sep. 17, 2026

(54) APPARATUS FOR INGRESS PROCESSING AND NETWORK ROUTERS FOR A HIERARCHICAL FABRIC

(71) Applicant: Intel Corporation, Santa Clara, CA (US)

(72) Inventors: Robert PAWLOWSKI, Beaverton, OR (US); Gurpreet Singh KALSI, Portland, OR (US)

(21) Appl. No.: 19/428,592

(22) Filed: Dec. 22, 2025

Related U.S. Application Data
(60) Provisional application No. 63/917,305, filed on Nov. 14, 2025.

(51) Int. Cl. H04L 45/24; H04L 45/745

(52) U.S. Cl. CPC H04L 45/24; H04L 45/745

(57) ABSTRACT

It is provided an apparatus comprising a first data path configured to process a read or write network transaction request. The apparatus comprises a second data path, parallel to the first data path, configured to process a multicast network transaction request. The second data path comprises a multicast destination circuitry configured to generate a destination bit-vector based on the multicast network transaction request. The second data path further comprises a packetization circuitry configured to form a multicast packet comprising the destination bit-vector for injection into the hierarchical fabric.

### BACKGROUND

High-performance computing and for example artificial intelligence systems may utilize distributed architectures with multiple processing elements that communicate through network infrastructures. In such systems, multicast communication patterns, wherein a single source transmits data to multiple destinations simultaneously, may be used for operations such as data distribution, synchronization, and coordination across distributed resources. As system complexity increases and configurations become more diverse, network fabrics may need to support flexible connectivity while maintaining performance characteristics.

### BRIEF DESCRIPTION OF THE FIGURES

Some examples of apparatuses and/or methods will be described in the following by way of example only, and with reference to the accompanying figures, in which

FIG. 1 illustrates an apparatus, for example an apparatus for ingress processing in a hierarchical fabric;

FIG. 2 comprises a method for ingress processing;

FIG. 3 illustrates an example multi-chiplet system;

FIG. 4 illustrates an example chiplet comprising a hierarchical fabric with endpoint port allocations and ingress processing blocks;

FIG. 5 illustrates a block diagram of a chiplet network architecture;

FIG. 6 illustrates an example multicast packet flow through a hierarchical fabric;

FIG. 7 illustrates an example implementation of the apparatus for ingress processing in a hierarchical fabric;

FIG. 8 illustrates an example structure of the Multicast Destination Table within the apparatus;

FIG. 9 illustrates a network router;

FIG. 10 illustrates method for network routing;

FIG. 11 illustrates a network router;

FIG. 12 illustrates a method for network routing;

FIG. 13 illustrates an example router implementation for a hierarchical fabric;

FIG. 14 illustrates a labeled diagram of a 2-level FatTree hierarchical fabric with router and port numbering;

FIG. 15 illustrates example hardware description code for implementing leaf router multicast logic;

FIG. 16 illustrates a flow diagram for spine router multicast processing; and

FIG. 17 illustrates network-on-chip system.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In some examples, multicast support in multiprocessor systems including data centers and high-performance computing systems may range from software-layer implementations to hardware-based designs. In software-based approaches, parallel computing runtimes may provide libraries and functions that may facilitate collective communication, including multicast operations. For example, message passing interface implementations may provide broadcast functions that may be used in conjunction with tree-based algorithms to distribute data across multiple processing elements. Inter-node multicast operations in software-based systems may be handled through read and write operations to shared memory regions that may be accessible by multiple processing elements.

Higher-performance implementations may leverage dedicated hardware resources within the system. For example, various network-on-chip protocols may support multicast operations between cores on an on-die network, with different routing algorithms that may be employed to optimize packet distribution. For inter-node multicast operations, communication may be facilitated within network interface controllers using address filtering techniques that may identify pre-defined multicast addresses. In some examples, network interface controllers may support offloading of multicast packet generation operations, reducing processing burden on host processors.

The apparatus, methods, and systems described herein may provide hardware multicast operations in a scalable glueless network fabric. The disclosed designs may support multicast operations across various configurations of compute resources, memory interfaces, and I/O connectivity on a chiplet. In some examples, the disclosed designs may support multicast operations across multiple chiplets in glueless (switchless) scale-up configurations within a rack. In some examples, the disclosed designs may support multicast operations in scale-out configurations across multiple racks.

The disclosed implementations may provide performance advantages compared to software-based implementations by enabling packets to traverse through the network-on-chip and between chiplets along determined paths with reduced request overhead. Software-based methods may require additional orchestration operations and memory access operations for shared memory communication, which may introduce latency and processing overhead. Hardware-based techniques implemented at the network-on-chip level may not scale beyond a single chiplet, potentially requiring different support mechanisms for multi-die implementations. Systems employing direct chiplet-to-chiplet connectivity without dedicated external switching components may not be able to rely on network interface controller support for facilitating multi-chiplet multicast operations. In some examples, such systems may benefit from the hardware multicast implementations described herein, which may enable seamless multicast distribution across chiplet boundaries without requiring external switching devices.

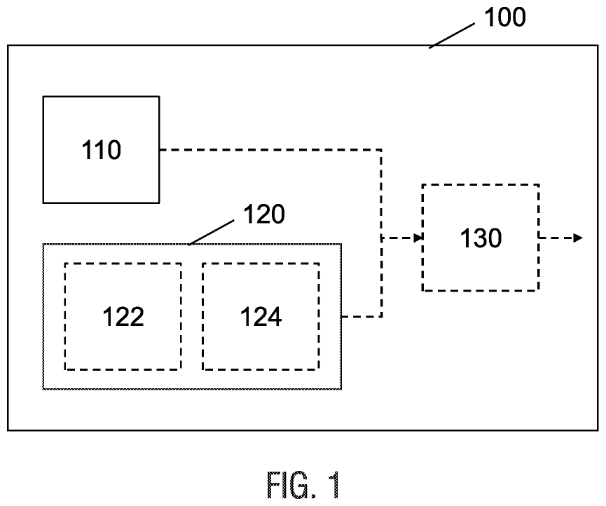

FIG. 1 illustrates an apparatus 100, for example an apparatus 100 for ingress processing in a hierarchical fabric. For example, the apparatus 100 may be implemented as part of a network-on-chip (NoC) system, which may provide on-die interconnect infrastructure for communication between multiple processing elements, memory elements, and input/output elements integrated on a single semiconductor die or distributed across multiple chiplets in a package. For example, the NoC systems may be particularly beneficial in chiplet-based computing systems for high-performance computing (HPC) or artificial intelligence (AI) applications, where high bandwidth, low latency communication between numerous compute cores and memory devices may be required to support data-intensive workloads such as neural network training, large-scale simulations, or parallel data processing.

The apparatus 100 may perform ingress processing, which may refer to the initial handling and processing of incoming network transaction requests before they are injected into the network fabric. Ingress processing may include operations such as address translation, route determination, permission checking, packet formation, and flow control. The apparatus 100 may receive transaction requests from various sources, such as compute cores, memory controllers, or input/output (I/O) interfaces, and may prepare these requests for transmission through the network fabric to their intended destinations.

The hierarchical fabric may refer to a network topology organized in multiple tiers or levels of routing elements. In one example, the hierarchical fabric may comprise a plurality of leaf routers and a plurality of spine routers. The leaf routers may be positioned at a lower tier and may connect directly to endpoint interfaces such as compute cores, memory devices, scratchpad memory, or I/O ports for inter-chiplet or inter-rack communication. The spine routers may be positioned at a higher tier and may interconnect the leaf routers to provide communication paths between different leaf routers. This hierarchical organization may enable scalable bandwidth and efficient routing across multiple endpoints while maintaining low network diameter and high bisection bandwidth.

In some examples, the apparatus 100 and the hierarchical fabric may be implemented on a single semiconductor die. This on-die integration may provide high bandwidth, low latency communication between the apparatus 100 and the network fabric. The apparatus 100 may be positioned at the edge of the hierarchical fabric, serving as an interface between transaction sources (such as protocol interface blocks) and the internal network structure. Multiple instances of the apparatus 100 may be distributed around the periphery of the hierarchical fabric, with each instance serving as an ingress point for one or more endpoint interfaces.

The hierarchical fabric may implement a fat-tree topology, wherein multiple paths may exist between any pair of leaf routers through different spine routers. For example, the hierarchical fabric may comprise a two-level fat-tree with 16 leaf routers and 8 spine routers, supporting up to 128 external ports. The apparatus 100 may inject packets into this fabric through one of the leaf routers, and the hierarchical routing structure may forward the packets to their destinations through the spine routers and destination leaf routers.

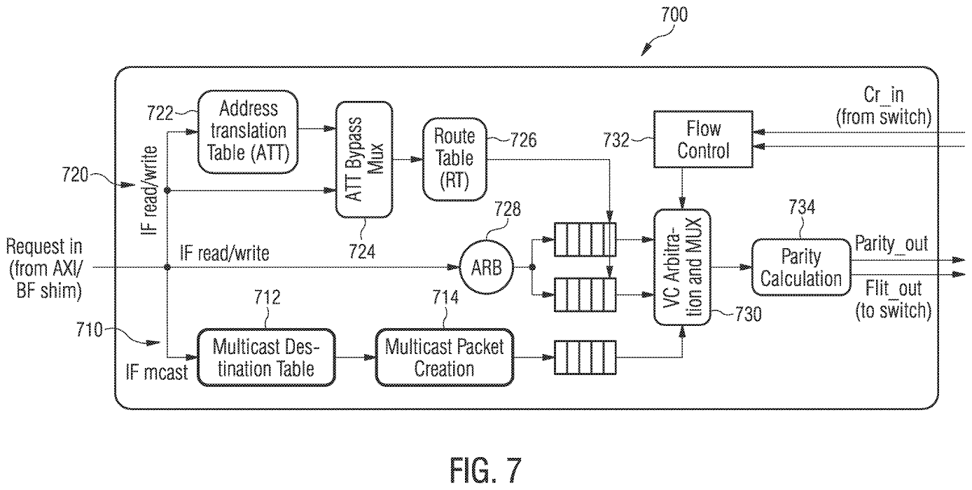

In some examples, the apparatus 100 may be implemented as a Bifrost Packet Address Compute (BF-PAC) unit, which may serve as an ingress processing block for a scalable hierarchical network fabric (see for example FIG. 7). The BF-PAC unit may be responsible for translating incoming transaction requests into network packets suitable for routing through the hierarchical fabric. The apparatus 100 may support composable network architectures, wherein the allocation of network ports to different types of endpoints (such as compute cores, high-bandwidth memory (HBM), scratchpad memory, or scale-up/scale-out I/O interfaces) may be configured based on system requirements. The apparatus 100 may enable glueless scaling, wherein direct chiplet-to-chiplet or chip-to-chip connectivity may be achieved without requiring dedicated external network switch devices, thereby reducing system complexity and improving performance for scale-up configurations within a rack and scale-out configurations across multiple racks.

The apparatus 100 comprises a first data path 110 configured to process a read or write network transaction request. For example, the first data path 110 may handle point-to-point communication operations, wherein a single source endpoint may request to read data from or write data to a single destination endpoint. These read or write transactions may constitute the majority of network traffic in typical computing systems, as they may represent memory accesses, cache line fills, data stores, I/O operations, and other unicast (one-to-one) communication patterns.

The first data path 110 may perform one or more processing operations to prepare a read or write request for transmission through the hierarchical fabric. These operations may include determining where the destination endpoint is located within the system (address translation), determining which network path should be taken to reach that destination (route determination), and formatting the request into a proper packet structure for injection into the network. The first data path 110 may be optimized for high throughput and may support various transaction types, burst sizes, and quality-of-service levels.

In some examples, the first data path 110 may comprise an address translation table (ATT) and a route table (RT). The address translation table may translate a system-level physical address included in the read or write request into a network-level destination identifier. For example, the address translation table may map a 64-bit physical memory address to a specific port number within the hierarchical fabric, thereby identifying which leaf router and which local port on that leaf router corresponds to the target memory location. The address translation table may be implemented as a content-addressable memory (CAM), a hash table, or a multi-level page table structure, and may be programmable via configuration register writes to support different system memory maps and endpoint allocations.

The route table may determine the routing path through the hierarchical fabric based on the destination identifier. For example, the route table may specify which output port of the local leaf router should be used to forward a packet toward a particular destination leaf router, taking into account the fat-tree topology and available paths through the spine routers. The route table may implement adaptive routing algorithms that select among multiple available paths based on congestion status, link availability, or load balancing policies. The route table may be implemented as a lookup table indexed by destination identifiers, or as algorithmic routing logic that computes routes based on destination addresses and network topology parameters.

In some examples, the first data path 110 may further comprise packetization logic that formats the translated address, routing information, transaction data, and control fields into a network packet suitable for injection into the hierarchical fabric. The first data path 110 may also comprise buffering and flow control logic to manage the rate at which packets are injected into the network based on available credits or back-pressure signals from the network.

For example, a second data path (which will be described in detail below) may bypass the address translation table and the route table of the first data path. This bypass may provide a shortcut that skips the complex and time-consuming address translation and routing lookups required for read/write requests, resulting in lower latency for multicast operations. Whereas read and write transactions require address translation to determine a single destination endpoint, multicast transactions may target multiple destination endpoints simultaneously based on a pre-configured multicast group, and thus may not require the same address translation and route computation operations. By bypassing these tables, the second data path may achieve faster processing of multicast requests and may reduce contention for shared lookup resources between the two data paths.

The apparatus 110 comprises a second data path 120, parallel to the first data path. The second path being parallel to the first path may indicate that the second data path 120 may operate concurrently with the first data path 110, allowing both read/write transactions and multicast transactions to be processed simultaneously without blocking each other. The parallel arrangement may improve overall throughput by enabling independent processing of different transaction types. The first data path 110 and second data path 120 may be implemented as separate, dedicated hardware circuits that operate in parallel, or alternatively, may share common hardware resources with time-multiplexed access, wherein control logic selects which data path is active at any given time. For example, shared resources such as output buffers, arbitration logic, or flow control circuits may be time-multiplexed between the two paths, while path-specific logic such as the address translation table (for the first path) and multicast destination circuitry (for the second path) may remain separate.

The second data path 120 is configured to process a multicast network transaction request. The multicast network transaction request may be to a communication operation wherein a single source endpoint wishes to send the same data or message to multiple destination endpoints simultaneously. This may differ from a unicast transaction (processed by the first data path 110), wherein data is sent from one source to one destination, and from a broadcast transaction, wherein data is sent to all possible endpoints in the system. In a multicast operation, the set of destination endpoints may be specifically defined and may constitute a subset of all available endpoints in the network.

Multicast operations may be useful in parallel computing systems, such as HPC and AI workloads, for several common communication patterns. For example, multicast may be used for cache coherency protocols, wherein a cache line invalidation message may need to be sent to multiple processor cores that are sharing a particular memory location. Multicast may be used for data distribution, wherein training data or model parameters may need to be replicated to multiple compute accelerators during neural network training. Multicast may be used for synchronization barriers, wherein a signal indicating completion of a computational phase may need to be sent to all participating cores in a parallel algorithm. Multicast may also be used for interrupt delivery, wherein a single interrupt source may need to notify multiple interrupt handlers or service routines across different processing elements.

The multicast network transaction request may be received by the apparatus 100 from a source endpoint, such as a compute core, memory controller, or I/O interface. The request may include several pieces of information: a multicast operation identifier that specifies which group of destination endpoints should receive the message, payload data to be delivered to those endpoints, and control information such as the requester identity, transaction type, and quality-of-service requirements. Unlike read or write requests that contain a single physical address identifying one destination, the multicast network transaction request may contain a multicast identifier that represents a pre-configured group of multiple destinations.

The second data path 120 may process the multicast network transaction request differently than the first data path 110 processes read/write requests. Rather than performing address translation to identify a single destination endpoint, the second data path 120 may perform a lookup of the multicast identifier to determine which multiple endpoints should receive the multicast packet. Rather than computing a single routing path through the network, the second data path 120 may generate routing information that enables the network fabric itself to replicate and distribute the packet to all intended destinations efficiently.

The first data path 110 and second data path 120 may be implemented as separate, parallel hardware circuits with independent processing pipelines. In this configuration, the first data path 110 may include dedicated address translation circuitry, route determination circuitry, and packetization circuitry for read/write transactions, while the second data path 120 may include separate, dedicated multicast destination circuitry and packetization circuitry for multicast transactions. This fully parallel implementation may enable simultaneous processing of both transaction types and may maximize throughput at the cost of increased hardware area.

In some examples, the first data path 110 and second data path 120 may share one or more hardware resources while maintaining separate processing paths for path-specific operations. For example, the address translation table and route table may remain dedicated to the first data path 110, and the multicast destination circuitry may remain dedicated to the second data path 120, but both paths may share common packetization logic, output buffering, and arbitration circuitry. Control logic may select which input source (read/write request or multicast request) feeds into the shared packetization logic at any given time. This partially shared implementation may balance area efficiency with processing throughput.

In some examples, the first data path 110 and second data path 120 may be implemented as time-multiplexed operation of substantially the same hardware resources. For example, a single processing pipeline may be configured to operate in a first mode for processing read/write transactions (utilizing the address translation table and route table) and in a second mode for processing multicast transactions (utilizing the multicast destination circuitry and bypassing the address translation table and route table). Mode selection logic may determine which processing path is active based on the transaction type, and arbitration logic may schedule when each transaction type is processed. This time-multiplexed implementation may minimize hardware area at the cost of reduced simultaneous processing capability.

The second data path 120 may comprise a multicast destination circuitry 122 configured to generate a destination bit-vector based on the multicast network transaction request. The destination bit-vector may be a data structure comprising a plurality of bits, wherein each bit corresponds to a specific endpoint port in the hierarchical fabric. The length of the destination bit-vector may correspond to the total number of endpoint ports available in the network. For example, in a hierarchical fabric supporting 128 endpoint ports, the destination bit-vector may be a 128-bit value, wherein bit position 0 corresponds to endpoint port 0, bit position 1 corresponds to endpoint port 1, and so forth up to bit position 127 corresponding to endpoint port 127.

Each bit in the destination bit-vector may indicate whether the corresponding endpoint port should receive the multicast packet. For example, a bit value of ‘1’ (or logical high) may indicate that the corresponding endpoint port is a destination for the multicast operation and should receive the multicast packet, while a bit value of ‘0’ (or logical low) may indicate that the corresponding endpoint port is not a destination and should not receive the multicast packet. Alternatively, the polarity may be reversed, with ‘0’ indicating a destination and ‘1’ indicating a non-destination.

The destination bit-vector may thus encode a multicast group as a bitmap, wherein the pattern of set bits identifies precisely which subset of all available endpoint ports should receive the multicast message. For example, a destination bit-vector of 128 bits with bits 5, 17, 33, and 64 set to ‘1’ and all other bits set to ‘0’ would indicate that the multicast packet should be delivered to endpoint ports 5, 17, 33, and 64, but not to any other ports. This bitmap representation may enable efficient multicast distribution through the hierarchical fabric, as routers within the fabric may examine the bit-vector to determine which output ports require packet replication.

For example, the multicast destination circuitry 122 may generate the destination bit-vector based on information contained in the multicast network transaction request. The multicast network transaction request may include a multicast operation identifier (also termed multicast Op ID or multicast ID), which may be a numeric value that identifies a particular pre-configured multicast group. For example, the multicast operation identifier may be a 6-bit value allowing up to 64 different multicast groups to be defined, or may be a larger value such as an 8-bit, 16-bit, or 32-bit identifier to support more multicast groups.

The multicast destination circuitry 122 may use the multicast operation identifier as an index or key to retrieve the corresponding destination bit-vector from a storage structure. For example, the multicast operation identifier may be used as a direct index into a lookup table, wherein the identifier value directly addresses a particular entry in the table, and that entry contains the pre-stored destination bit-vector for that multicast group. The retrieval operation may be a simple array access or memory read, providing low-latency lookup of the destination information.

For example, the destination bit-vectors for various multicast groups may be pre-configured by system software, such as operating system drivers, firmware, or runtime libraries. Software may program the multicast destination circuitry 122 by writing the desired bit-vector patterns into configuration registers or memory locations associated with each multicast operation identifier. This programmability may allow the system to dynamically define and modify multicast groups based on application requirements, workload characteristics, or system topology changes.

For example, in a system supporting cache coherency protocols, one multicast group may be configured to include all processor cores sharing a particular cache coherency domain, and the corresponding destination bit-vector would have bits set for all ports connected to those processor cores. In a system performing distributed neural network training, another multicast group may be configured to include all GPU accelerators participating in a particular training job, with the destination bit-vector identifying the ports connected to those GPUs. Different multicast groups may overlap in membership, such that some endpoint ports may be members of multiple multicast groups and would appear as set bits in multiple destination bit-vectors.

The destination bit-vector may be configured to identify, as a target endpoint port, an egress port of the hierarchical fabric. An egress port may be an output port of the network fabric through which packets exit to reach external destinations. The egress port may be coupled to an egress translation block configured to encode information from the multicast packet into a transaction for a standard interface protocol. The egress translation block may convert the internal packet format used within the hierarchical fabric into a transaction formatted according to an industry-standard chip-to-chip or chiplet-to-chiplet communication protocol.

For example, the standard interface protocol may be an AXI (Advanced extensible Interface) protocol, which is widely used for on-chip and inter-chiplet communication. The egress translation block may extract the payload data, control information, and destination bit-vector from the multicast packet and may encode this information into AXI transaction fields such as address fields, data fields, transaction identifiers, and user-defined sideband signals. The multicast operation identifier may be encoded into AXI user bits or extension fields to preserve the multicast group information across the inter-chiplet link.

For example, other standard interface protocols may include PCIe (Peripheral Component Interconnect Express), CXL (Compute Express Link), UCIe (Universal Chiplet Interconnect Express), Ethernet, or other industry-standard interconnect protocols. The egress translation block may be configurable or may include protocol-specific logic to support one or more of these standards. By encoding the multicast information into standard protocol transactions, the hierarchical fabric may extend multicast operations beyond a single chiplet or die, enabling multi-chiplet or multi-chip multicast distribution in a composable system.

When a multicast packet reaches an egress port that connects to another chiplet, the egress translation block may encapsulate the multicast information into the standard protocol transaction, which then traverses the inter-chiplet physical link. At the receiving chiplet, a corresponding ingress translation block may decode the standard protocol transaction back into the internal packet format, extract the multicast operation identifier, and inject the reconstructed multicast packet into that chiplet's hierarchical fabric for further distribution to local destination endpoints. This process may repeat across multiple chiplets, allowing a single multicast operation initiated on one chiplet to propagate seamlessly to destination endpoints distributed across multiple chiplets in the system, all without requiring dedicated external switch devices or software intervention at each hop.

The multicast destination circuitry 122 may be implemented in various configurations to perform the lookup and retrieval of destination bit-vectors. The multicast destination circuitry 122 may comprise various storage and access structures such as lookup tables, content-addressable memories, hash tables, or other indexable storage mechanisms.

For example, the multicast destination circuitry 122 may comprise a table structure indexed by the multicast operation identifier included in the multicast network transaction request. The table structure may be organized as an array or memory with multiple entries, wherein each entry stores a destination bit-vector and associated control information for a particular multicast group. The multicast operation identifier may serve as a direct index into this table structure, such that the identifier value directly addresses a specific entry position within the table. The use of indexed lookup may provide very fast access to the destination bit-vector. Rather than requiring a search operation through multiple entries or a comparison against stored keys, the multicast operation identifier may be used directly as an address or index, allowing the hardware to retrieve the correct entry in a single memory access cycle or a small fixed number of cycles. For example, if the multicast operation identifier is a 6-bit value, it may directly index into a table with 64 entries (2\hat{ }6=64), wherein identifier value 0 accesses entry 0, identifier value 1 accesses entry 1, and so forth. This direct indexing technique may be implemented using address decoding logic that activates the appropriate word line in a register array or SRAM structure, or using multiplexer logic that selects the appropriate entry from a bank of registers based on the identifier value.

Each entry in the table structure may comprise the destination bit-vector for the corresponding multicast group, as well as permission information. The permission information may be security-related data that specifies which requesters are authorized to initiate multicast operations on that particular multicast group. For example, the permission information may include a requester identifier field, a security domain identifier, privilege level indicators, or access control bits that define which sources may use the multicast group.

The permission information may be used to implement firewalling and isolation between different security domains, process contexts, or virtual machines running on the system. For example, in a system where multiple tenants or applications share the same hardware resources, the permission information may prevent one tenant from sending multicast messages to another tenant's resources, even if both tenants' endpoints are connected to the same hierarchical fabric. The permission information may also prevent malicious or compromised software from exploiting multicast operations to perform unauthorized communication, denial-of-service attacks by flooding multiple endpoints, or information leakage by multicasting sensitive data to unintended recipients.

The table structure may be implemented using various hardware storage technologies. For example, the table may be implemented as an array of registers, wherein each entry is a register holding the destination bit-vector and permission information, and the multicast operation identifier drives multiplexer select lines to choose which register's contents are output. Alternatively, the table may be implemented using SRAM (static random-access memory) cells, wherein the multicast operation identifier is applied to the SRAM address inputs, and the SRAM read port outputs the selected entry. The table may also be implemented using configuration registers that are memory-mapped into the system address space, allowing software to read and write the entries via standard load and store operations.

The destination bit-vectors for various multicast groups may be pre-configured by system software, such as operating system drivers, firmware, or runtime libraries. Software may program the multicast destination circuitry 122 by writing the desired bit-vector patterns and permission information into the table structure via configuration register writes. This programmability may allow the system to dynamically define and modify multicast groups based on application requirements, workload characteristics, or system topology changes.

For example, in a system supporting cache coherency protocols, one multicast group may be configured to include all processor cores sharing a particular cache coherency domain, and the corresponding destination bit-vector would have bits set for all ports connected to those processor cores, with permission information restricting access to the coherency protocol hardware. In a system performing distributed neural network training, another multicast group may be configured to include all GPU accelerators participating in a particular training job, with the destination bit-vector identifying the ports connected to those GPUs and permission information allowing the training framework software to initiate multicasts to that group. Different multicast groups may overlap in membership, such that some endpoint ports may be members of multiple multicast groups and would appear as set bits in multiple destination bit-vectors.

The second data path 120 may be further configured to authorize the multicast network transaction request based on a requester identity and the permission information stored in the table structure. The requester identity may be information included in or derived from the multicast network transaction request that identifies the source of the request. For example, the requester identity may include a core identifier indicating which processor core initiated the request, a process identifier or address space identifier indicating which software context is executing, a security domain identifier, a privilege level indicator, or other identification information.

The authorization operation may be performed prior to the multicast destination circuitry 122 generating or outputting the destination bit-vector. For example, when the multicast network transaction request arrives at the second data path 120, the multicast destination circuitry 122 may first retrieve the entry from the table structure corresponding to the multicast operation identifier, extract the permission information from that entry, and compare the permission information against the requester identity. If the comparison indicates that the requester is authorized to access the specified multicast group, the multicast destination circuitry 122 may then output the destination bit-vector from the retrieved entry and allow the multicast operation to proceed. If the comparison indicates that the requester is not authorized, the multicast destination circuitry 122 may block the operation, drop the request, generate an error response, or trigger a security exception.

This authorization mechanism may prevent unauthorized multicast operations and may enforce isolation between different security domains, applications, or tenants sharing the hardware. For example, permission information for a multicast group used by a first application may specify that only cores running that first application's processes are authorized to use that group, preventing a second application from multicasting to the first application's endpoints. The authorization check may be performed in hardware by the multicast destination circuitry 122, providing low-latency security enforcement without software intervention on each multicast operation.

In some examples, the multicast destination circuitry 122 may be programmable via configuration register writes. The table structure may be implemented such that each entry is accessible via memory-mapped register addresses in the system address space. Software may perform standard write operations to these register addresses to modify the destination bit-vectors and permission information, enabling dynamic reconfiguration of multicast groups without requiring hardware changes or system resets.

This register-based programmability may allow the system to adapt multicast configurations to changing workload requirements. For example, when cores are dynamically allocated or deallocated from a parallel computation, the driver may update the destination bit-vectors to reflect the current set of participating cores. When system topology changes due to chiplet hotplug events or resource reallocation, the multicast groups may be reprogrammed to match the new endpoint connectivity. This flexibility may be particularly beneficial in virtualized or multi-tenant environments where resource assignments change frequently.

The second data path 120 may further comprise packetization circuitry 124 configured to form a multicast packet comprising the destination bit-vector for injection into the hierarchical fabric. The packetization circuitry 124 may receive the destination bit-vector generated by the multicast destination circuitry 122 and may assemble a complete network packet that can be transmitted through the hierarchical fabric to reach the intended destination endpoints. The formation of the multicast packet may involve combining several pieces of information into a structured packet format recognized by the routers in the hierarchical fabric.

The packet may comprise the destination bit-vector, which specifies which endpoint ports should receive the packet. The packet may also comprise payload data from the multicast network transaction request, representing the actual information to be delivered to the destination endpoints, such as cache coherency messages, synchronization signals, shared data values, or interrupt notifications. The packet may further comprise the multicast operation identifier, which may be carried through the network to enable any necessary operations at intermediate routers or at the destination endpoints. Additional packet fields may include control information such as packet type indicators, priority or quality-of-service fields, sequence numbers, source identifiers, and integrity check values such as parity bits or cyclic redundancy check (CRC) codes.

The packetization circuitry 124 may arrange these various components into a defined packet structure with specific field positions and formats. For example, the packet may have a header section containing control fields and the destination bit-vector, followed by a payload section containing the transaction data, and optionally a footer section containing integrity check information. The specific packet format may be tailored to the requirements of the hierarchical fabric's routing protocol and the capabilities of the routers within the fabric.

The multicast packet comprises the destination bit-vector because the routers within the hierarchical fabric may use this bit-vector to determine how to forward and replicate the packet. Each router may examine the destination bit-vector to identify which of its output ports lead to destination endpoints. For local ports directly connected to destination endpoints, the router may forward a copy of the packet to those ports. For ports leading to other routers that provide paths to destination endpoints, the router may forward the packet (potentially with a modified bit-vector) to those routers. By including the destination bit-vector in the packet itself, the multicast distribution logic may be distributed throughout the network fabric, with each router independently determining its role in the multicast tree without requiring centralized coordination or pre-configured routing state.

The formed multicast packet may be injected into the hierarchical fabric, meaning that the packet is transmitted from the apparatus 100 into the network fabric where it begins traversing through the routers toward the destination endpoints. Injection may involve placing the packet into an input buffer or queue of a leaf router, asserting flow control signals to indicate packet availability, and transferring the packet data over the physical or logical connection between the apparatus 100 and the leaf router. Once injected, the packet becomes subject to the routing, forwarding, and replication mechanisms of the hierarchical fabric, which progressively deliver copies of the packet to all endpoints identified in the destination bit-vector.

For example, the packetization circuitry 124 may be implemented as combinational logic comprising multiplexers, concatenation logic, and bit manipulation circuits. In a combinational implementation, the packetization circuitry 124 may include a set of multiplexers that select packet field values from various input sources. One multiplexer input set may receive the destination bit-vector from the multicast destination circuitry 122, another set may receive payload data from the multicast network transaction request, another may receive the multicast operation identifier, and others may receive control and status information. The multiplexer select signals may be controlled by packet format configuration or by state signals indicating which fields should be included in the current packet.

The combinational logic may further include concatenation circuits that join the selected fields into a contiguous bit stream forming the complete packet. For example, bit fields may be concatenated by arranging them into specific bit positions of an output vector, such as placing control bits in positions [127:120], the destination bit-vector in positions [119:0], and so forth, depending on the packet format specification. The combinational logic may also include computation circuits for generating integrity check values. For example, an XOR tree may compute parity across selected packet fields, or a CRC generator circuit may compute a cyclic redundancy check value across the packet contents.

In some examples, the packetization circuitry 124 may be implemented as a finite state machine (FSM) that sequences through multiple stages of packet assembly. The FSM implementation may be beneficial when packet formation requires multiple clock cycles, when packet length is variable, or when coordination with flow control and buffering is required. The FSM may include states such as IDLE, HEADER_FORMATION, VECTOR_INSERTION, PAYLOAD_INSERTION, CRC_CALCULATION, and OUTPUT. In the IDLE state, the FSM may wait for a multicast network transaction request to arrive. Upon receiving a request, the FSM may transition to HEADER_FORMATION, where it may assemble packet header fields. The FSM may then transition to VECTOR_INSERTION, where it may insert the destination bit-vector received from the multicast destination circuitry 122. In PAYLOAD_INSERTION, the FSM may transfer payload data from the request into the packet. The FSM may then compute integrity check values in CRC_CALCULATION before transitioning to OUTPUT to transmit the completed packet to the hierarchical fabric.

The FSM implementation may include state registers holding the current state, next-state logic determining state transitions based on current state and control signals, and output logic generating control signals and data selections based on the current state. The FSM may also include datapath registers for temporarily storing intermediate results during multi-cycle packet assembly, counters for tracking progress through variable-length fields, and control flags for managing handshaking with upstream sources (the multicast destination circuitry 122) and downstream sinks (the hierarchical fabric input interface).

As described previously, the packetization circuitry 124 may also be implemented as a hybrid of combinational logic and finite state machine elements. For example, the FSM may provide high-level control and sequencing, managing the overall flow of packet assembly and coordinating handshakes with other blocks, while combinational datapaths under FSM control may perform the actual field selection, bit manipulation, and integrity calculation operations. This hybrid approach may balance the simplicity and low latency of combinational logic with the flexibility and multi-cycle capability of state machine control.

The multicast destination circuitry 122 and the packetization circuitry 124 may be functional blocks. In some examples, they may be implemented as separate, independent hardware blocks, wherein each block has dedicated logic circuits, storage elements, and control paths. In some examples, the multicast destination circuitry 122 and packetization circuitry 124 may be implemented as a single integrated hardware block, wherein the lookup and packetization functions are performed by shared logic resources. For example, a single finite state machine may control both the retrieval of the destination bit-vector from the table structure and the assembly of the multicast packet using the same datapath elements. The FSM may sequence through states that first perform the indexed lookup and permission checking operations, and then transition to states that perform packet field insertion and formatting operations, all using shared multiplexers, datapaths, and control logic.

The above described apparatus 100 may enable efficient hardware-accelerated multicast operations in a scalable hierarchical fabric while maintaining low latency and high configurability. By providing dedicated parallel data paths for read/write transactions and multicast transactions, the apparatus 100 may allow both transaction types to be processed concurrently without contention, thereby improving overall system throughput. The second data path may bypass the address translation table and route table that are required for unicast transactions, providing a hardware shortcut that eliminates complex and time-consuming lookup operations and results in significantly lower latency for multicast operations compared to software-based implementations. The use of a destination bit-vector to encode multicast group membership may enable efficient packet replication within the hierarchical fabric, as routers may examine the bit-vector to determine local and remote destinations without requiring centralized coordination or pre-configured routing state. The programmable multicast destination circuitry may provide flexibility to dynamically configure multicast groups based on workload requirements, system topology, or security policies through software-controlled register writes, enabling adaptation to changing application needs without hardware modifications. The apparatus 100 may support glueless scaling across multiple chiplets and racks by enabling multicast packets to be encoded into standard interface protocols at egress ports, allowing seamless propagation of multicast operations across chiplet boundaries without requiring dedicated external switch devices or software intervention at each hop. Apparatus 100 may be used for high-performance computing and artificial intelligence workloads that rely heavily on collective communication patterns such as cache coherency, data distribution, synchronization barriers, and interrupt delivery across many processing elements.

The apparatus 100 may further comprise arbitration circuitry 130 configured to select between an output of the first data path 110 and an output of the second data path 120 for injection into the hierarchical fabric. The arbitration circuitry 130 may act as a traffic controller that merges the two separate streams of packets from the parallel data paths into a single output stream that is injected into the hierarchical fabric. Since both the first data path 110 and the second data path 120 may generate packets for injection into the network, and since the hierarchical fabric may have limited input bandwidth or may accept only one packet at a time at a given injection point, the arbitration circuitry 130 may resolve conflicts when both data paths have packets ready for injection simultaneously. The arbitration circuitry 130 may ensure fair access to the network injection port, preventing one data path from monopolizing the network bandwidth and starving the other data path.

The arbitration circuitry 130 may operate by monitoring ready signals or valid signals from both the first data path 110 and the second data path 120, wherein these signals indicate when each data path has a packet ready for injection. When only one data path has a packet ready, the arbitration circuitry 130 may select that data path and may allow its packet to be injected into the hierarchical fabric. When both data paths have packets ready simultaneously, the arbitration circuitry 130 may apply an arbitration policy to select one of the data paths. The arbitration policy may be a round-robin scheme that alternates selection between the two data paths to provide fair bandwidth allocation. Alternatively, the arbitration policy may be a priority-based scheme wherein one data path (for example, the multicast data path) is given higher priority than the other, allowing latency-sensitive multicast operations to be serviced preferentially. The arbitration policy may also consider quality-of-service fields, packet age, or other factors to make selection decisions. Once a data path is selected, the arbitration circuitry 130 may enable that data path's output to propagate to the hierarchical fabric input interface, while providing back-pressure or flow control signals to the non-selected data path indicating that it should hold its current packet for the next arbitration cycle.

The arbitration circuitry 130 may be implemented as combinational logic comprising priority encoders, multiplexers, and control signal generation circuits. For example, a priority encoder may examine the ready signals from both data paths and may generate a selection signal indicating which data path should be granted access. A multiplexer controlled by this selection signal may route the packet data from the selected data path to the output port leading to the hierarchical fabric. Control logic may generate acknowledgment signals back to the selected data path indicating that its packet has been accepted, and may generate blocking signals to the non-selected data path indicating that it must wait. Alternatively, the arbitration circuitry 130 may be implemented as a finite state machine that maintains arbitration state across multiple cycles, such as tracking which data path was last granted access (for round-robin arbitration) or tracking packet ages (for age-based arbitration). The arbitration circuitry 130 may also include buffering elements such as small FIFOs or holding registers that temporarily store packets from one or both data paths during arbitration, allowing the data paths to continue preparing subsequent packets while the current arbitration cycle completes.

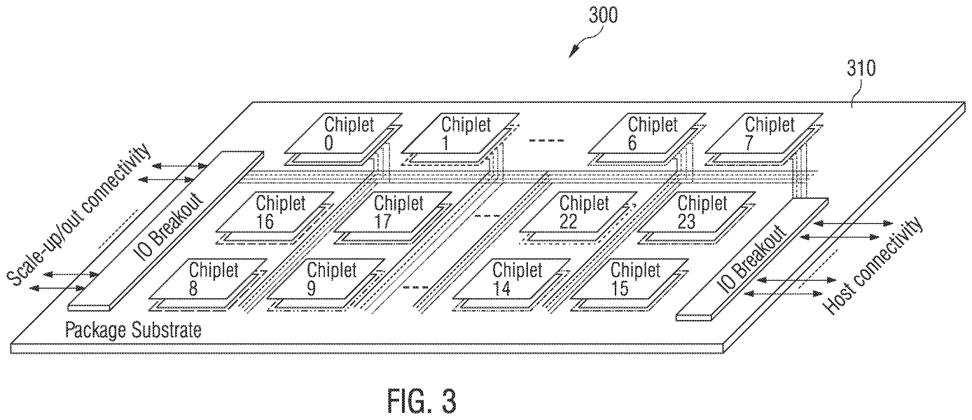

Further details and aspects are mentioned in connection with the examples described below. The example shown in FIG. 1 may include one or more optional additional features corresponding to one or more aspects mentioned in connection with the proposed concept or one or more examples described below (e.g., FIGS. 3-17).

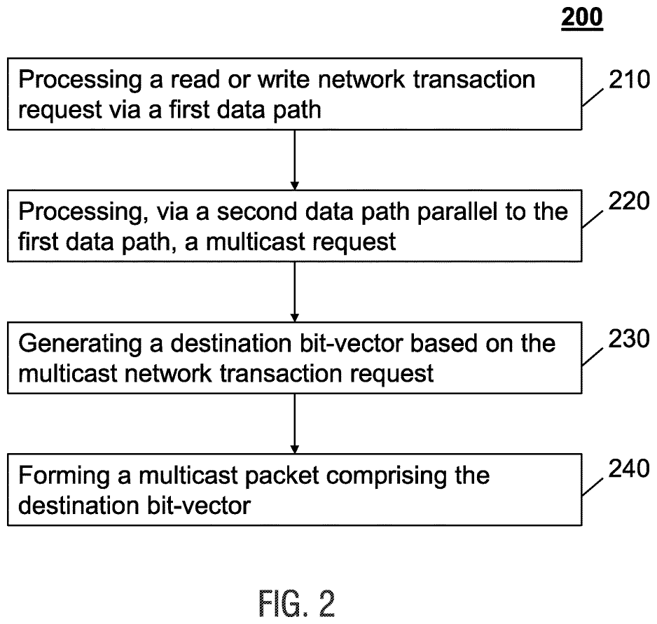

FIG. 2 comprises a method 200 for ingress processing. The method 200 may, for instance, be performed by an apparatus as described herein, such as apparatus 100. The method 200 comprises processing 210 a read or write network transaction request via a first data path. The method 200 comprises further processing 220, via a second data path parallel to the first data path, a multicast network transaction request. The processing via the second data path comprises generating 230 a destination bit-vector based on the multicast network transaction request and forming 240 a multicast packet comprising the destination bit-vector for injection into a hierarchical fabric.

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-7).

As described in connection with FIG. 1 and FIG. 2, the apparatus 100 may be implemented as part of a network-on-chip system for high-performance computing and artificial intelligence applications. The hierarchical fabric in which the apparatus 100 operates may be part of a larger multi-chiplet system designed to address the scaling challenges of modern computing workloads. Efficient scale-up and scale-out network fabrics may be a key to increasing performance in state-of-the-art AI systems. Current network approaches commonly take a distinct approach of multi-chiplet sockets communicating via a dedicated top-of-rack switch device, with scale-out consisting of another layer of system switches for inter-rack communication. Current state-of-the-art system fabrics (i.e., NoC, chiplet-to-chiplet, and scale-up/scale-out) may be limited in terms of bandwidth, synchronization, and data sharing scalability, which may be a near- and long-term concern for AI system innovation.

To unlock the power of the chiplet architecture, the ideal chiplet interconnect may deliver high bandwidth while supporting both intra-chiplet communication and seamless multi-chiplet scaling. Conventional methods of scaling through distributed hierarchical networks may struggle to deliver the required bandwidth within small silicon footprints. Additionally, current scale-up and scale-out solutions may lack a unified memory space across chiplets, creating specific bottlenecks in workload distribution, memory management, and overall performance scaling.

The future of high-performance computing (HPC) and artificial intelligence (AI) may lie in adopting a holistic system design approach. In this vision, the hardware system architecture may span from chiplets to packages to multiple racks, operating as a unified compute entity. This approach may require a modular, distributed interconnect network capable of delivering high bandwidth and low latencies across the system. By implementing switching functionality directly into compute and memory chiplets as a distributed switch, this goal may be achieved. Advanced packaging with 3D-stacked memory may address the “memory wall” problem through higher bandwidth. The integrated, distributed network may further complement this design, providing a strong foundation critical for data-intensive workloads.

A composable network architecture (meaning flexible across different system sizes and design targets) may form the core of such a scalable network design. The apparatus 100 described in connection with FIG. 1 and FIG. 2 may be a component of such a composable system. Routers may be leveraged as fundamental building blocks, allowing chiplets to connect modularly like building blocks to enable seamless scalability. This approach may maintain critical performance metrics including bandwidth, latency, and throughput. Other benefits may include fewer protocol translations as packets traverse the system and elimination of dedicated network switch components in small-to medium-scale systems, as the hierarchical fabric described previously provides distributed switching functionality.

A component in highly parallel systems may be the capability of cores to communicate with each other via multicast-type messages, as addressed by the apparatus 100 and its second data path 120. Specifically, this may be the ability for one core to place a message on the network and have it progress through the network only to specifically intended target (destination) cores. This may differ from a broadcast operation in that the broadcast will ship the message to all endpoints of the fabric. Multicast-style operations may include coherency messages, data sharing, synchronization, or interrupt messages. Most state-of-the-art networks may provide hardware assistance to improve performance for multicast operations due to the frequency of these types of messages issued in multi-core systems. The apparatus 100 provides such hardware assistance through its multicast destination circuitry 122 and packetization circuitry 124 as described above.

Implementing multicast support in a high bandwidth, scalable, and composable system may have several challenges that the apparatus 100 addresses. While the composability may be beneficial for creating scalable and unified systems, it may result in network connections that are not always consistent between system configurations. For example, a chiplet NoC (hierarchical fabric) may have any number of ports connected to compute cores, memory devices, and scale-up/scale-out I/O interfaces. The apparatus 100 may provide flexibility through its programmable multicast destination circuitry 122, which may be configured via register writes to accommodate different port allocations without requiring hardware changes, thereby limiting programming complexity overheads. Scalable solutions may require efficient targeting of destination endpoints on other chiplets across the system (i.e., on a different rack). The apparatus 100 may address this through its destination bit-vector mechanism, which may optimally identify destination endpoints and enable efficient routing through the chiplet network, extending out to properly connected inter-chiplet paths. In a system with no dedicated network switch, multicast support may need to be embedded into the chiplet NoC hardware and may need to seamlessly pass packets between chiplets in the switch-less (glueless) system fabric. The apparatus 100 may be integrated with the hierarchical fabric on a single semiconductor die, and may support inter-chiplet multicast through egress translation blocks that encode multicast information into standard interface protocols. If multicast trees are exposed in the network hardware, security and firewalling may be imperative to prevent bad actors from accessing isolated domains. The apparatus 100 may address this through the permission information stored in the table structure and the authorization checking performed by the second data path 120.

FIG. 3 illustrates an example multi-chiplet system 300. The multi-chiplet system 300 comprises a composable network fabric with scale-up and scale-out connectivity. The system 300 may represent a high-performance computing or artificial intelligence system wherein multiple chiplets are integrated on a package substrate to form a unified computing platform. Each chiplet in the system 300 may include one or more instances of the apparatus 100 described in connection with FIG. 1 and FIG. 2, along with the hierarchical fabric comprising leaf routers and spine routers as described previously. The system 300 may demonstrate the composable and scalable nature of the network architecture, supporting various system configurations ranging from small chiplet counts to large-scale multi-rack deployments.

The system 300 comprises a package substrate 310 on which multiple chiplets are mounted. For example, the system 300 may include chiplet 0 to chiplet 23 arranged in a grid-like configuration. While FIG. 3 shows a 24-chiplet configuration, the composable network architecture may support a higher number of chiplets with a 2-level fat-tree topology using high-radix routers (for example, 16×16 routers) in the chiplet Network-on-Chip (NoC) (hierarchical fabric). This may enable sufficient bandwidth for both scale-up and scale-out connectivity.

Each chiplet may include internal network-on-chip infrastructure comprising the hierarchical fabric with leaf routers and spine routers as described previously in connection with FIG. 1 and FIG. 2. Each chiplet may further include multiple instances of the apparatus 100 positioned at the periphery of the hierarchical fabric, serving as ingress processing points for transaction requests from various endpoint interfaces. The chiplets may be interconnected via direct chiplet-to-chiplet links, enabling glueless (switchless) scaling without requiring dedicated external switch devices. The direct connectivity may be facilitated by I/O interfaces on each chiplet that connect to egress ports of the hierarchical fabric, which may be coupled to egress translation blocks configured to encode information from multicast packets into transactions for standard interface protocols such as AXI, PCIe, CXL, or UCIe.

The system 300 further comprises I/O breakout regions 320 and 330 positioned at opposite sides of the package substrate 310. I/O breakout 320 may provide scale-up/out connectivity to external systems or other packages, while I/O breakout 330 (indicated as “Host connectivity”) may provide connections to host processors, storage systems, or other system-level resources. These I/O breakout regions may enable the system 300 to scale beyond a single package, supporting multi-package configurations within a rack (scale-up) and multi-rack configurations across a datacenter (scale-out). Multicast operations initiated by an apparatus 100 on one chiplet may propagate seamlessly across these inter-chiplet and inter-package links to reach destination endpoints distributed throughout the system 300, without requiring software intervention at each hop.

The network features of the system 300 may include high bandwidth (for example, 820 TB/s for 24 chiplets), low latency (for example, sub-100 ns), and scale-up/out options using standard interface protocols such as UAL, UEC, or CXL. The chiplet logic layer features may include resiliency, security, compression, telemetry, compute capabilities, and acceleration functions. These features may be distributed across the chiplets and may be coordinated via the network fabric and the multicast capabilities provided by the apparatus 100.

The composable nature of the system 300 may allow chiplets to connect modularly, enabling seamless scalability while maintaining critical performance metrics including bandwidth, latency, and throughput. The system 300 may eliminate the need for dedicated network switch components in small-to medium-scale configurations by implementing switching functionality directly into the compute and memory chiplets as a distributed switch through the hierarchical fabric. This approach may reduce protocol translations as packets traverse the system and may enable a unified memory space across chiplets, addressing bottlenecks in workload distribution, memory management, and overall performance scaling. The multicast support provided by the apparatus 100 in each chiplet may be essential to enabling efficient communication patterns required by parallel computing workloads across this distributed, composable system.

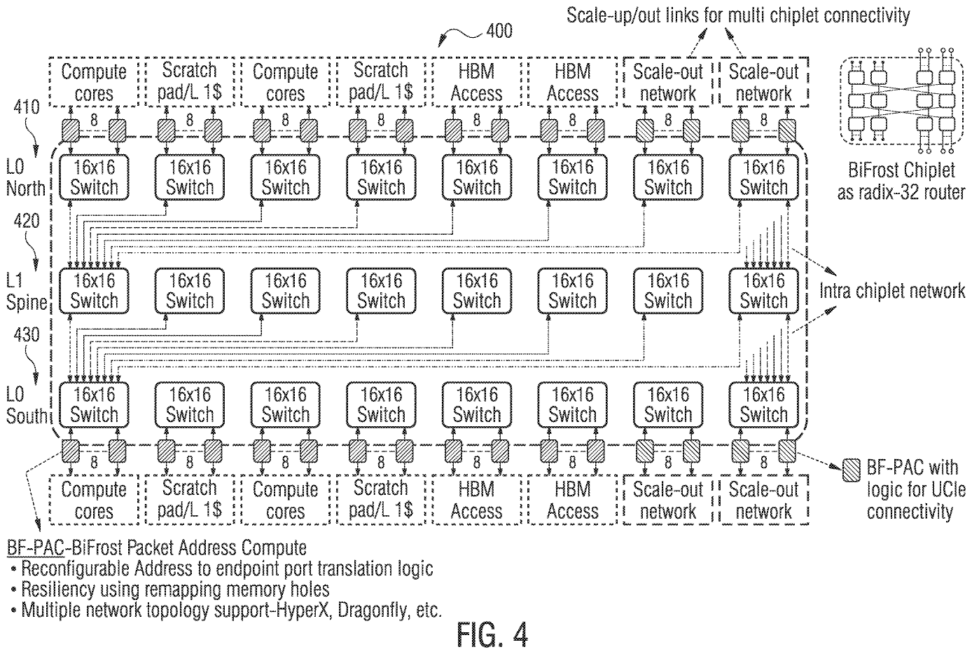

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-17).

FIG. 4 illustrates an example chiplet 400 comprising a hierarchical fabric with endpoint port allocations and ingress processing blocks. The chiplet 400 may represent a single chiplet within the multi-chiplet system 300 described in connection with FIG. 3. The chiplet 400 may demonstrate the internal network-on-chip architecture that enables high bandwidth, low latency communication between various types of endpoints while supporting composable port allocation and glueless multi-chiplet connectivity.

The hierarchical fabric of the chiplet 400 may leverage a high-radix and low-diameter network-on-chip architecture to provide the per-chiplet bandwidth to scale-up (within a rack) and scale-out (rack-to-rack) to an extent that supports current and future AI systems. The hierarchical fabric may be implemented as a 2-level fat-tree topology of high-radix routers, supporting up to 128 endpoints per chiplet. This architecture may enable the multicast operations described in connection with FIG. 1 and FIG. 2 to be efficiently implemented and distributed throughout the network fabric.

The chiplet 400 comprises three tiers of routers forming the hierarchical fabric. The first tier comprises a plurality of leaf routers 410 designated as L0 North, positioned at the top of the fabric. The second tier comprises a plurality of spine routers 420 designated as L1 Spine, positioned in the middle of the fabric. The third tier comprises a plurality of leaf routers 430 designated as L0 South, positioned at the bottom of the fabric. For example, the chiplet 400 may include eight leaf routers in the L0 North tier, eight spine routers in the L1 Spine tier, and eight leaf routers in the L0 South tier, each implemented as a 16×16 switch (router) supporting 16 bidirectional ports.

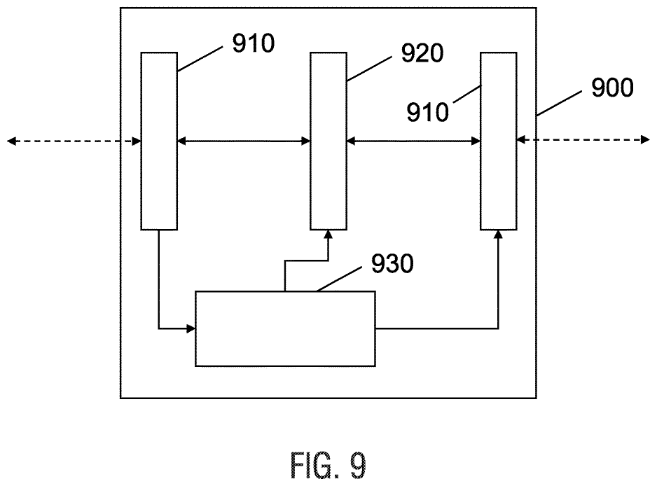

The leaf routers 410 and 430 may connect directly to endpoint interfaces, while the spine routers 420 may interconnect the leaf routers to provide communication paths between different leaf routers. This hierarchical organization may enable the multicast operations described previously, wherein multicast packets injected at one leaf router may be forwarded to spine routers, which may then replicate the packets to multiple destination leaf routers based on the destination bit-vector (see for example FIGS. 9 to 16)

The hierarchical fabric of the chiplet 400 may be composable, meaning that the 128 endpoint ports (8 ports per leaf router×16 leaf routers=128 ports) may be allocated between different types of endpoints including compute cores, memory devices, and I/O interfaces based on system requirements. The configuration shown in FIG. 4 allocates the 128 ports across multiple endpoint types to demonstrate the flexibility of the architecture.

The L0 North tier 410 may connect to various types of endpoints at the top of the chiplet. For example, the endpoints may include compute cores, scratchpad memory (also designated as scratchpad pad/L1$ indicating level-1 cache or scratchpad functionality), HBM (High Bandwidth Memory) access interfaces, and scale-out network interfaces for inter-chiplet connectivity. Specifically, the configuration shown in FIG. 4 allocates 32 ports for compute cores (for example, 8 ports each to four compute core groups), 32 ports for scratchpad memory (for example, 8 ports each to four scratchpad/L1$ groups), 32 ports for HBM access (for example, 8 ports each to four HBM access groups), and 32 ports for scale-out network interfaces (for example, 8 ports each to four scale-out network groups). The scale-out network interfaces shown in red may be designated as BF-PAC blocks with logic for UCIe connectivity, indicating that these interfaces may support Universal Chiplet Interconnect Express protocol for inter-chiplet communication.

Similarly, the L0 South tier 430 may connect to corresponding endpoint types at the bottom of the chiplet, mirroring the allocation scheme of the L0 North tier. This symmetrical configuration may provide balanced bandwidth distribution across the chiplet and may enable efficient routing through the spine routers 420.

The apparatus 100 described in connection with FIG. 1 and FIG. 2 may be integrated within the chiplet 400 at the interfaces between the endpoint ports and the hierarchical fabric. For example, multiple instances of the apparatus 100 may be positioned at each connection point where an endpoint interface meets a leaf router port. The apparatus 100 may serve as the ingress processing block, receiving transaction requests from the endpoints (compute cores, memory interfaces, I/O interfaces) and preparing these requests for injection into the hierarchical fabric through the leaf routers.

For example, the apparatus 100 may be implemented as a BF-PAC (Bifrost Packet Address Compute) block. The BF-PAC may provide reconfigurable address-to-endpoint port translation logic, resiliency using remapping for memory holes, and multiple network topology support including HyperX, Dragonfly, and other topologies. Each packet entering the chiplet network may access the apparatus 100 (BF-PAC) for local route determination. The apparatus 100 may include the first data path 110 for processing read and write transactions using the address translation table and route table as described previously, and may include the second data path 120 for processing multicast network transaction requests using the multicast destination circuitry 122 and packetization circuitry 124 as described previously.

The glueless connectivity approach of the chiplet 400 may require on-die network blocks such as the apparatus 100 that can generate route information from a system-level perspective, meaning that the destination port on the local chiplet must be determined based on the target system physical address. For unicast transactions processed by the first data path 110, the apparatus 100 may perform address translation to map system physical addresses to local network ports. For multicast transactions processed by the second data path 120, the apparatus 100 may generate the destination bit-vector that identifies multiple target endpoints across the hierarchical fabric, bypassing the address translation table and route table to provide lower latency operation.

The chiplet 400 may support glueless scale-up and scale-out with direct chiplet-to-chiplet connectivity through the scale-out network interfaces. The scale-out network interfaces shown in red may include egress translation blocks as described for example in connection with FIG. 9, which may encode information from multicast packets into transactions for standard interface protocols such as UCIe, AXI, PCIe, or CXL. When a multicast packet generated by the apparatus 100 reaches an egress port connected to a scale-out network interface, the egress translation block may encapsulate the multicast information including the destination bit-vector and multicast operation identifier into the standard protocol transaction, enabling the multicast operation to propagate seamlessly to other chiplets in the system 300 without requiring software intervention.

The intra-chiplet network connections shown as colored lines connecting the leaf routers 410, spine routers 420, and leaf routers 430 may represent the internal data paths of the hierarchical fabric through which packets may be routed. These connections may form the fat-tree topology, wherein multiple paths may exist between any pair of leaf routers through different spine routers, enabling high bisection bandwidth and efficient multicast distribution.

The BiFrost Chiplet shown in the upper right corner of the figure may be represented as a radix-32 router from a system-level perspective, meaning that the chiplet 400 as a whole may present 32 external I/O links (corresponding to the 32 scale-out network ports shown in red) for multi-chiplet connectivity. These scale-up/out links may enable the chiplet 400 to connect directly to other chiplets in the system 300, forming the composable, glueless fabric described in connection with FIG. 3.

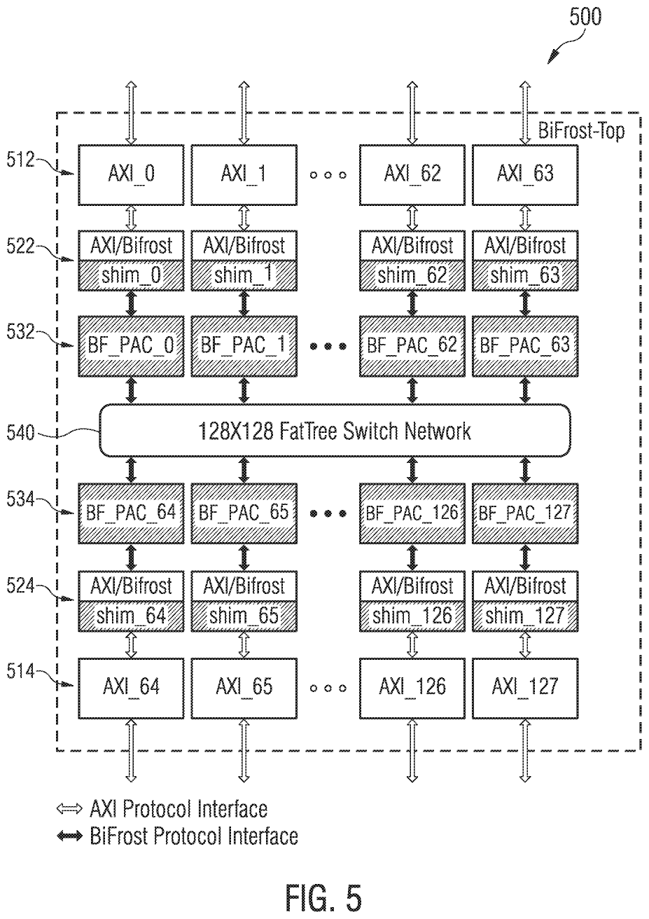

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-17).

FIG. 5 illustrates a block diagram 500 of a chiplet network architecture. The chiplet network architecture 500 includes protocol interface blocks, translation shims, and ingress processing apparatus. The block diagram 500 may show the integration of multiple instances of the apparatus 100 (described in connection with FIG. 1 and FIG. 2) within the chiplet 400 (described in connection with FIG. 4). The block diagram 500 may demonstrate how the apparatus 100 interfaces with external protocol interfaces and with the hierarchical fabric to enable efficient packet ingress processing for both unicast and multicast operations.

The block diagram 500 comprises a plurality of protocol interface blocks 512 and 514 positioned at the top and bottom periphery of the chiplet network. The protocol interface blocks may implement standard interface protocols for communication between the chiplet network and external endpoints or other chiplets. For example, the protocol interface blocks 512 may include AXI_0, AXI_1, AXI_62, and AXI_63 (with intermediate interfaces indicated by ellipsis), implementing the AXI (Advanced extensible Interface) protocol. Similarly, the protocol interface blocks 514 at the bottom may include AXI_64, AXI_65, AXI_126, and AXI_127. The system 500 may support up to 128 protocol interfaces (AXI_0 through AXI_127), corresponding to the 128 endpoint ports of the hierarchical fabric described in connection with FIG. 4.

While FIG. 5 shows AXI interfaces at each network port, the chiplet network may support many different standard interface protocols with a custom shim at the interfaces. For example, the protocol interface blocks may alternatively or additionally implement protocols such as PCIe (Peripheral Component Interconnect Express), CXL (Compute Express Link), UCIe (Universal Chiplet Interconnect Express), or other industry-standard interconnect protocols. The use of standard interface protocols at the periphery may enable the chiplet to communicate with various types of endpoints including compute cores, memory controllers, I/O devices, and other chiplets using widely adopted communication standards. The block diagram 500 further comprises a plurality of translation shim blocks 522 and 524 positioned between the protocol interface blocks and the apparatus blocks. The translation shim blocks may convert transactions between the external protocol format (for example, AXI format) and the internal network packet format used within the hierarchical fabric (for example, Bifrost protocol format). The translation shims 522 at the top may include AXI/Bifrost shim_0, AXI/Bifrost shim_1, AXI/Bifrost shim_62, and AXI/Bifrost shim_63, providing bidirectional conversion between AXI transactions and Bifrost packets. Similarly, the translation shims 524 at the bottom may include AXI/Bifrost shim_64, AXI/Bifrost shim_65, AXI/Bifrost shim_126, and AXI/Bifrost shim_127.

The translation shim blocks may perform protocol conversion including field mapping, data width adaptation, flow control translation, and signaling conversion. For ingress operations, a translation shim may receive an AXI transaction from an external endpoint, extract relevant information such as addresses, data, control signals, and transaction identifiers, and may forward this information to the corresponding apparatus 100 for processing. For egress operations, a translation shim may receive a packet from the hierarchical fabric, convert the packet back into an AXI transaction format, and may transmit the transaction to the external endpoint through the protocol interface block.

For multicast operations extending across chiplets, the translation shim may serve as the egress translation block for example, described in connection with FIG. 9. When a multicast packet reaches an egress port of the hierarchical fabric 540 that is connected to an inter-chiplet link, the translation shim may encode information from the multicast packet (including the destination bit-vector, multicast operation identifier, and payload data) into a transaction formatted for the standard interface protocol. The encoded transaction may then traverse the inter-chiplet physical link to another chiplet, where a corresponding ingress translation shim may decode the transaction back into the internal packet format and may inject it into that chiplet's hierarchical fabric for further multicast distribution.

The block diagram 500 further comprises a plurality of apparatus blocks 532 and 534 positioned between the translation shims and the hierarchical fabric. Each apparatus block may be an instance of the apparatus 100 described in connection with FIG. 1 and FIG. 2, serving as an ingress processing block for packets entering the hierarchical fabric. The apparatus blocks 532 at the top may include BF_PAC_0, BF_PAC_1, BF_PAC_62, and BF_PAC_63 (indicating BF-PAC blocks 0, 1, 62, and 63). The apparatus blocks 534 at the bottom may include BF_PAC_64, BF_PAC_65, BF_PAC_126, and BF_PAC_127. The system 500 may include 128 instances of the apparatus 100, one for each endpoint port of the hierarchical fabric.

Each apparatus 100 (BF-PAC block) may receive transaction requests from its associated translation shim, may perform ingress processing as described previously, and may inject packets into the hierarchical fabric 540. The apparatus 100 may include the first data path 110 for processing read and write network transaction requests using the address translation table and route table, and may include the second data path 120 for processing multicast network transaction requests using the multicast destination circuitry 122 and packetization circuitry 124. The apparatus 100 may further include the arbitration circuitry 130 for selecting between outputs of the first and second data paths for injection into the hierarchical fabric.

The block diagram 500 further comprises the hierarchical fabric 540, illustrated as a 128×128 FatTree Switch Network. The hierarchical fabric 540 may correspond to the three-tier router architecture shown in FIG. 4, comprising the L0 North leaf routers 410, the L1 Spine routers 420, and the L0 South leaf routers 430. The hierarchical fabric 540 may provide full connectivity between all 128 apparatus blocks, enabling any endpoint to communicate with any other endpoint through the distributed routing infrastructure.

The arrows in the block diagram 500 may indicate the direction of data flow and the protocol types at different stages of the communication path. Gray arrows with the label “AXI Protocol Interface” may indicate AXI protocol transactions flowing between external endpoints and the protocol interface blocks 512 and 514. Black arrows with the label “BiFrost Protocol Interface” may indicate Bifrost internal packet format flowing between the translation shims 522 and 524, through the apparatus blocks 532 and 534, and into/out of the hierarchical fabric 540.

The focus of the multicast support described in this disclosure may be on the programmability of endpoints in the hierarchical fabric (FatTree NoC), the flow of multicast packets through the routers, and how to enable high performance hardware multicasts in glueless scale-up/scale-out systems. The specific details of the inter-chiplet communication for multicast support may be I/O protocol dependent and may consist of encodings within those standard interface protocols. The multicast destination circuitry 122 within each apparatus 100 may generate the destination bit-vector that enables efficient multicast distribution through the hierarchical fabric 540, while the packetization circuitry 124 may form multicast packets that can be processed by the routers within the fabric. When multicast packets reach egress ports connected to inter-chiplet links, the translation shims may encode the multicast information into the appropriate standard protocol format, enabling seamless multi-chiplet multicast propagation as described in connection with FIG. 3.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-17).

The multicast support provided by the apparatus 100 and the hierarchical fabric may enable a straightforward and performant method for creating multicast trees across various groupings of destinations that can seamlessly progress over a glueless (direct chiplet-to-chiplet connectivity) scale-up and scale-out network. The multicast implementation may address several key aspects of the system architecture. First, the multicast destination circuitry 122 within the apparatus 100 (BF-PAC) may support multiple multicast trees for both inter-chiplet and intra-chiplet communication, with programmable destination bit-vectors and permission information to enforce isolation rules and firewalling of tree access from requesting ports. Second, additional logic within the on-die routers (leaf routers and spine routers of the hierarchical fabric) may determine where to pass multicast packets through the network and when replication of packets needs to occur based on the destination bit-vector. Third, the translation shim blocks may enable multicast operations to extend seamlessly across chiplet boundaries by encoding multicast information into standard interface protocol transactions.

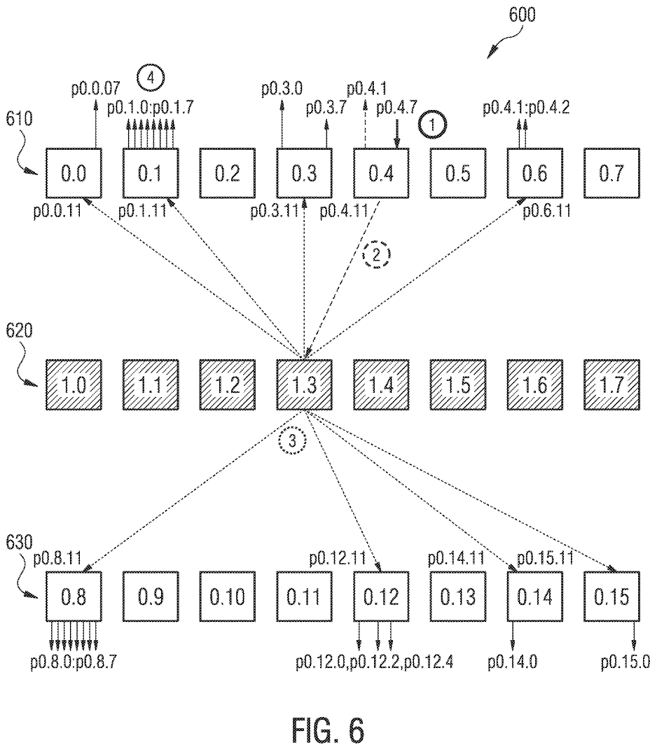

FIG. 6 illustrates an example multicast packet flow 600 through a hierarchical fabric. The multicast flow 600 may demonstrate how a multicast network transaction request progresses through the three-tier router architecture of the hierarchical fabric described in connection with FIG. 4, and how the destination bit-vector generated by the apparatus 100 may be used by the routers to determine packet forwarding and replication. The example shown in FIG. 6 may represent the packet flow of a multicast operation through a chiplet network within a scale-up configuration. Any size of system, ranging from a single chiplet to large scale-out configurations, may follow the same general packet flow conventions.

The multicast flow 600 comprises three tiers of routers corresponding to the hierarchical fabric structure described previously. The first tier comprises a plurality of leaf routers 610 (designated as routers 0.0 through 0.7), shown in blue, positioned at the top of the fabric. The second tier comprises a plurality of spine routers 620 (designated as routers 1.0 through 1.7), shown in green, positioned in the middle of the fabric. The third tier comprises a plurality of leaf routers 630 (designated as routers 0.8 through 0.15), shown in blue, positioned at the bottom of the fabric. This arrangement may correspond to the L0 North leaf routers 410, L1 Spine routers 420, and L0 South leaf routers 430 described in connection with FIG. 4.

The multicast flow 600 demonstrates a sequence of steps, labeled with numbered circles (1, 2, 3, 4), showing the progression of a multicast packet through the hierarchical fabric. The multicast packet may be generated by an instance of the apparatus 100 positioned at an ingress port of the hierarchical fabric, where the apparatus 100 may receive a multicast network transaction request from an endpoint, may generate the destination bit-vector via the multicast destination circuitry 122, may form the multicast packet via the packetization circuitry 124, and may inject the multicast packet into the hierarchical fabric.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-17).

FIG. 7 illustrates an example implementation 700 of the apparatus 100 for ingress processing in a hierarchical fabric. The implementation 700 may demonstrate a detailed block diagram of the Bifrost Packet Address Compute (BF-PAC) described in connection with FIG. 1 and FIG. 2, showing the internal structure of the first data path 110 and the second data path 120 and how these paths process different types of network transaction requests. The implementation 700 may correspond to an instance of the apparatus 100 positioned at one of the 128 network ports in the chiplet network architecture shown in FIG. 5 (for example, one of BF_PAC_0 through BF_PAC_127).

Once a transaction request is converted from the standard interface protocol (for example, AXI) to the internal format by the translation shim (for example, AXI/Bifrost shim as shown in FIG. 5), the transaction request may be issued to the apparatus 700. The apparatus 700 may receive the request at an input labeled “Request in (from AXI/BF shim)” and may determine whether the request is a read/write transaction or a multicast network transaction request. This determination may be based on transaction type indicators or command fields included in the request.

The apparatus 700 comprises a first data path 720 configured to process read or write network transaction requests. The first data path 720 may be indicated by the label “IF read/write” showing the path taken by read and write transactions. The first data path 720 may comprise an Address Translation Table (ATT) 722, an ATT Bypass Mux 724, and a Route Table (RT) 726. Read and write transactions (i.e., non-multicast operations) may take the path through the Address Translation Table 722 and Route Table 726 to generate the target system address and routing information. The Address Translation Table 722 may translate a system-level physical address included in the read or write request into a network-level destination identifier, as described previously in connection with FIG. 1 and FIG. 2. The ATT Bypass Mux 724 may provide a mechanism to bypass the address translation operation for certain transaction types if needed. The Route Table 726 may determine the routing path through the hierarchical fabric based on the destination identifier, specifying which output port of the local leaf router should be used to forward the packet toward the destination.

The apparatus 700 further comprises a second data path 710 configured to process multicast network transaction requests, parallel to the first data path 720. The second data path 710 may be indicated by the label “IF mcast” showing the path taken by multicast transactions. The second data path 710 may comprise a Multicast Destination Table 712 (multicast destination circuitry 122) and a Multicast Packet Creation block 714 (packetization circuitry 124).

Multicast network transaction requests may not require address translation, instead performing a lookup of the destination bit-vector from the Multicast Destination Table 712 before packetization. The Multicast Destination Table 712 may be indexed by the multicast operation identifier included in the multicast network transaction request. Each entry in the Multicast Destination Table 712 may comprise the destination bit-vector identifying target endpoint ports and permission information for authorization checking, as described previously. The apparatus 700 may perform a permission check for the multicast operation identifier to ensure that the requesting source can access the targeted multicast tree. This authorization may be performed prior to the Multicast Destination Table 712 producing the destination bit-vector. The Multicast Destination Table 712 may be programmable via configuration register writes allowing software to dynamically configure multicast groups.

The Multicast Packet Creation block 714 may receive the destination bit-vector from the Multicast Destination Table 712 and may form the multicast packet including the destination bit-vector for injection into the hierarchical fabric. The Multicast Packet Creation block 714 may be implemented as combinational logic or a finite state machine. Following the Multicast Packet Creation block 714, the formed multicast packet may be queued in a multicast virtual channel (VC) buffer, shown as the series of buffer slots following block 714.

The second data path 710 may bypass the Address Translation Table 722 and the Route Table 726 used by the first data path 720. This bypass may provide a hardware shortcut that skips the complex and time-consuming address translation and routing lookups required for read/write requests, resulting in lower latency for multicast operations. The apparatus 700 further comprises an arbiter (ARB) 728 configured to select between an output of the first data path 720 and an output of the second data path 710 for further processing. The arbiter 728 may correspond to the arbitration circuitry 130. The arbiter 728 may merge the two separate streams of packets from the parallel data paths into a single output stream. The outputs of the first data path 720 (read/write packets) and the second data path 710 (multicast packets) may each be buffered in respective VC buffers (shown as the series of buffer slots following each path) before being selected by the arbiter 728.

The apparatus 700 further comprises a VC Arbitration and Mux block 730 positioned downstream of the arbiter 728. The VC Arbitration and Mux block 730 may perform virtual channel arbitration to select among multiple virtual channels (including the read/write VC and the multicast VC) and may multiplex the selected packet toward the output interface. The VC Arbitration and Mux block 730 may coordinate with a Flow Control block 732, which may receive credit signals (Cr_in) from the downstream switch (leaf router of the hierarchical fabric) to ensure that packets are only transmitted when the receiving router has available buffer space. This credit-based flow control may prevent buffer overflow and may enable back-pressure when the network is congested.

The apparatus 700 further comprises a Parity Calculation block 734 positioned at the output stage. The Parity Calculation block 734 may compute integrity check values (such as parity bits) for the outgoing packets. The outputs of the Parity Calculation block 734 may include Parity_out (the computed parity value) and Flit_out (the packet data to be transmitted to the switch). These outputs may be transmitted to the leaf router of the hierarchical fabric for injection into the network.

The implementation 700 may demonstrate how efficiently both unicast (read/write) and multicast transaction types may be handled through parallel data paths with specialized processing logic for each type. The first data path 720 may provide comprehensive address translation and routing for point-to-point transactions, while the second data path 710 may provide optimized, low-latency processing for multicast transactions by bypassing the address translation and route computation stages and instead using the pre-configured destination bit-vectors stored in the Multicast Destination Table 712.

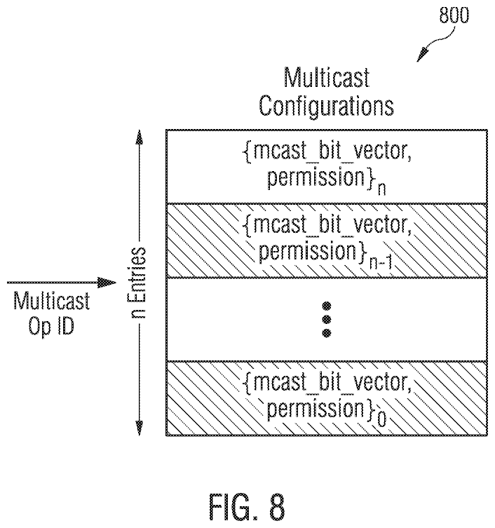

Further details and aspects are mentioned in connection with the examples described above or below. The example shown in FIG. 7 may include one or more optional additional features corresponding to one or more aspects mentioned in connection with the proposed concept or one or more examples described above (e.g., FIGS. 1-6) or below (e.g., FIGS. 8-17).

FIG. 8 illustrates an example structure 800 of the Multicast Destination Table 712 within the apparatus 700 or apparatus 100. The structure 800 may demonstrate how the multicast destination circuitry 122 (shown as the Multicast Destination Table 712 in FIG. 7) may be organized to store and retrieve destination bit-vectors and permission information for multicast operations. The structure 800 may correspond to the table structure, wherein the multicast destination circuitry comprises a table structure indexed by a multicast operation identifier.

The structure 800 comprises a plurality of entries organized as Multicast Configurations. Each entry in the structure 800 may contain two components: an mcast_bit_vector and permission information, shown as {mcast_bit_vector, permission}. The entries may be indexed from entry 0 at the bottom to entry n at the top, providing n total entries (n Entries as indicated by the vertical arrow on the left side of the figure). The number of entries n may be configurable based on system requirements, for example n may be 64 entries (supporting 64 different multicast groups) if the multicast operation identifier is a 6-bit value, or n may be larger (such as 256 or more entries) if a larger identifier field is used.

The entries may be indexed by a Multicast Op ID (multicast operation identifier), as indicated by the arrow on the left side of the structure 800. The Multicast Op ID may be extracted from the multicast network transaction request received by the apparatus 100. For example, the Multicast Op ID may be the upper 32 bits of a full identifier received with the multicast network transaction request, or may be a smaller field such as 6, 8, or 16 bits depending on the system configuration. The Multicast Op ID may serve as a direct index into the structure 800, such that the identifier value directly addresses a specific entry position within the table. This indexed lookup technique may provide very fast access to the destination bit-vector allowing the hardware to retrieve the correct entry in a single memory access cycle or a small fixed number of cycles.

Each entry in the structure 800 may contain an ‘i’-bit mcast_bit_vector (destination bit-vector), where ‘i’ may be the total number of endpoint ports on the hierarchical fabric (FatTree network). For example, in a hierarchical fabric supporting 128 endpoint ports as described in connection with FIG. 4 and FIG. 5, the mcast_bit_vector may be a 128-bit value. Each bit in the mcast_bit_vector may indicate whether the corresponding endpoint port should receive the multicast packet, as described previously in connection with FIG. 1 and FIG. 2. The pattern of set bits in the mcast_bit_vector may define which subset of all available endpoint ports forms the multicast group associated with that entry's Multicast Op ID.

Each entry in the structure 800 may further contain permission information. The permission information may specify which requesters are authorized to initiate multicast operations using that particular multicast group. For example, the permission information may include requester identifier fields, security domain identifiers, privilege level indicators, or access control bits. When the apparatus 100 receives a multicast network transaction request, the second data path 710 may retrieve the entry corresponding to the Multicast Op ID, may compare the requester identity from the request against the permission information in the entry, and may authorize or deny the multicast operation based on this comparison. This authorization may be performed prior to the multicast destination circuitry generating the destination bit-vector for use in packet formation.

The structure 800 may be implemented using various hardware storage technologies as described previously, including register arrays, SRAM cells, or configuration memory. The structure 800 may be programmable via configuration register writes allowing software such as device drivers, operating system kernels, or runtime libraries to configure and modify the multicast groups by writing desired mcast_bit_vector patterns and permission information to the appropriate entries.

Once the destination bit-vector has been extracted from the structure 800 (Multicast Destination Table 712), the Multicast Packet Creation block 714 (packetization circuitry 124) may form a multicast packet for injection into the hierarchical fabric. The multicast packet may include the payload data from the multicast network transaction request, the mcast_bit_vector (destination bit-vector) retrieved from the structure 800, the Multicast Op ID for potential use by downstream routers or destination chiplets, and packet control bits indicating packet type, priority, and other attributes. This packet information may be used by the routers (leaf routers and spine routers) within the hierarchical fabric to determine packet forwarding and replication, as described in connection with FIG. 6 and as will be further detailed in connection with subsequent figures describing router behavior.

Further details and aspects are mentioned in connection with the examples described above or below. The example shown in FIG. 8 may include one or more optional additional features corresponding to one or more aspects mentioned in connection with the proposed concept or one or more examples described above (e.g., FIGS. 1-7) or below (e.g., FIGS. 9-17).

### Leaf Router

FIG. 9 illustrates a network router 900. For example, the router 900 described with reference to FIG. 9 may incorporate elements, components, and concepts that have been described above with reference to FIGS. 1 to 8. The terminology, definitions, and technical details established in the preceding descriptions may apply equally to the router 900 unless explicitly stated otherwise. For example, the router 900 may be an on-die network router 900 for a hierarchical fabric. The network router 900 may be a hardware component within the hierarchical fabric that receives packets from input ports, determines the appropriate output ports for those packets based on routing information, and forwards the packets toward their destinations. The network router 900 may serve as a fundamental building block of the network-on-chip infrastructure, providing connectivity and packet switching functionality within the fabric.

An on-die network router may be a router that is implemented on the same semiconductor die as other components of the chiplet, such as compute cores, memory interfaces, and I/O interfaces. The on-die implementation may provide high bandwidth, low latency communication between the network router 900 and adjacent routers and endpoints within the hierarchical fabric. The network router 900 may be fabricated using the same semiconductor process as the other on-die components, enabling tight integration and efficient use of silicon area.

The network router 900 may be part of a hierarchical fabric, which may be a network topology organized in multiple tiers or levels of routing elements as described previously in connection with FIG. 1 through FIG. 8. In a hierarchical fabric, routers at different tiers may have different roles and connectivity patterns. Lower-tier routers may connect directly to endpoint interfaces (such as compute cores, memory devices, or I/O ports) and may handle traffic entering and exiting the network. Higher-tier routers may interconnect the lower-tier routers and may provide paths for traffic between different lower-tier routers.

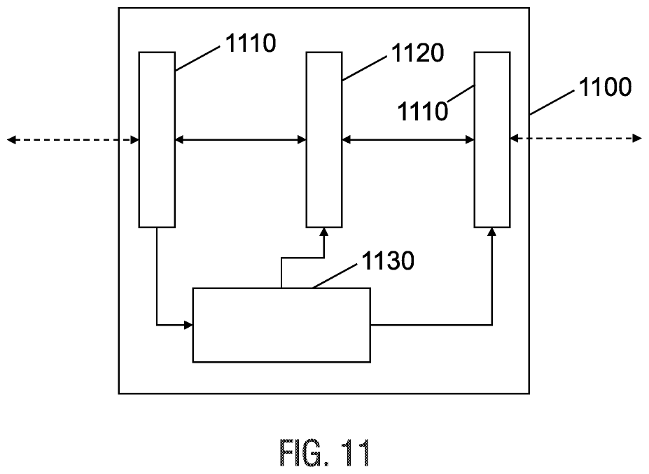

For example, the hierarchical fabric may implement a fat-tree topology, wherein the network comprises multiple levels of routers arranged in a tree-like structure with high bisection bandwidth. In a fat-tree topology, the network router 900 may be a leaf router positioned at the lowest tier of the hierarchy. The leaf router may connect directly to local endpoint interfaces on some of its ports and may connect to one or more higher-tier routers (spine routers) on other ports. The spine routers (see FIG. 11) may be positioned at a higher tier of the fat-tree topology and may interconnect multiple leaf routers, enabling communication between endpoints connected to different leaf routers.

In the context of the chiplet network architecture described in connection with FIG. 4, the network router 900 may correspond to one of the leaf routers 410 (L0 North) or leaf routers 430 (L0 South) shown in that figure. The network router 900 may connect to endpoint interfaces such as compute cores, scratchpad memory, HBM access interfaces, or scale-out network interfaces through its local ports, and may connect to the spine routers 420 (L1 Spine) through its upward-facing ports. The fat-tree topology may provide multiple parallel paths between any pair of leaf routers through different spine routers, enabling high aggregate bandwidth and fault tolerance.

The network router 900 may be configured to handle both unicast packets (addressed to a single destination endpoint) and multicast packets (addressed to multiple destination endpoints) as described in connection with the multicast flow shown in FIG. 6. For multicast operations, the network router 900 may include specialized multicast circuitry that determines which local ports and which higher-tier routers should receive copies of the multicast packet based on the destination bit-vector included in the packet.

The router 900 further comprises a plurality of bidirectional ports 910 configured for connection to local endpoint interfaces and at least one higher-tier router. The bidirectional ports 910 may be the physical and logical interfaces through which the network router 900 communicates with other components in the hierarchical fabric. Each bidirectional port 910 may support both incoming traffic (packets arriving at the router) and outgoing traffic (packets departing from the router), enabling full-duplex communication in both directions simultaneously.

The bidirectional ports 910 may be arranged around the periphery of the network router 900, providing multiple connection points for various types of network links. For example, in a 16×16 router implementation as described in connection with FIG. 4, the network router 900 may comprise 16 bidirectional ports 910, each capable of independent send and receive operations. The number of bidirectional ports 910 may vary based on the router radix (the number of ports supported by the router), with higher-radix routers providing more ports for increased connectivity.

Each bidirectional port 910 may be implemented as a combination of input and output interface logic. The input portion of the port may include input buffers (such as FIFO queues or virtual channel buffers) for temporarily storing incoming packets, input arbitration logic for managing access to shared router resources, and flow control logic for signaling buffer availability to upstream senders. The output portion of the port may include output buffers for holding packets awaiting transmission, output arbitration logic for selecting among packets destined for this port, and driver circuitry for transmitting packets on the physical link. The bidirectional ports 910 may further include serialization and deserialization logic if the physical links use serial signaling, clock domain crossing logic if different portions of the system operate at different clock frequencies, and error detection logic such as parity checkers.

A subset of the bidirectional ports 910 may be configured for connection to local endpoint interfaces. Local endpoint interfaces may be the connections between the network router 900 and the endpoints that generate and consume network traffic. The local endpoint interfaces may connect to various types of endpoints depending on the system configuration. For example, local endpoint interfaces may connect to compute cores (such as CPU cores or GPU processing elements) that issue read and write requests to memory and send multicast messages to other cores. Local endpoint interfaces may connect to memory controllers that provide access to high-bandwidth memory (HBM), scratchpad memory, or cache storage. Local endpoint interfaces may connect to I/O interfaces that communicate with external devices, other chiplets, or other systems. Local endpoint interfaces may also connect to instances of the apparatus 100 (BF-PAC) described in connection with FIG. 1 through FIG. 8, which perform ingress processing for transaction requests entering the hierarchical fabric.

The local endpoint interfaces may be implemented as protocol interface blocks with associated translation shims, as shown in FIG. 5. For example, an endpoint such as a compute core may communicate using a standard interface protocol (such as AXI), and a translation shim may convert between the standard protocol and the internal packet format used within the hierarchical fabric. The apparatus 100 may be positioned between the translation shim and the bidirectional port 910, performing address translation, route determination, and multicast destination lookup before packets are injected into the network router 900.

Another subset of the bidirectional ports 910 may be configured for connection to at least one higher-tier router. A higher-tier router may be a router positioned at a higher level in the hierarchical fabric, providing connectivity between multiple lower-tier routers. In the fat-tree topology described previously, the higher-tier routers may be the spine routers 420 (L1 Spine) shown in FIG. 4, while the network router 900 may be one of the leaf routers 410 or 430 (L0 North or L0 South). The connections between the network router 900 and the higher-tier routers may enable packets to traverse between different leaf routers by routing through the spine layer.

The allocation of bidirectional ports 910 between local endpoint interfaces and higher-tier router connections may be configurable based on system requirements. For example, in a leaf router with 16 bidirectional ports 910, eight ports may be allocated for connection to local endpoint interfaces and eight ports may be allocated for connection to spine routers. This allocation may provide balanced bandwidth between local traffic (entering and exiting through endpoints) and through traffic (traversing to other leaf routers via spine routers). The composable nature of the network architecture may allow different port allocations for different system configurations, as described in connection with FIG. 4 where the 128 total ports across all leaf routers are allocated among compute cores, scratchpad memory, HBM access, and scale-out network interfaces.

The connectivity pattern between the network router 900 and the higher-tier routers may follow the fat-tree topology structure. For example, each leaf router may connect to multiple spine routers, and each spine router may connect to multiple leaf routers, creating a fully connected bipartite graph between the leaf and spine tiers. This connectivity pattern may provide multiple parallel paths between any pair of leaf routers, enabling high bisection bandwidth and supporting adaptive routing where traffic can be distributed across available paths based on congestion conditions.

The router 900 further comprises a crossbar 920 configured to selectively connect the ports. The crossbar 920 may be the central switching element within the network router 900 that provides configurable connectivity between any input port and any output port. The crossbar 920 may enable packets arriving on any of the bidirectional ports 910 to be forwarded to any other of the bidirectional ports 910 based on routing decisions made by the router control logic. The crossbar 920 may be functionally connected between the input sides and output sides of the bidirectional ports 910. Packets arriving at a bidirectional port 910 may be received into input buffers associated with that port, and may then be transferred through the crossbar 920 to the output buffers of one or more destination ports 910 for transmission. The crossbar 920 may provide non-blocking connectivity, meaning that multiple simultaneous transfers between different input-output port pairs may occur in parallel without interference, provided that no two transfers target the same output port at the same time.

The crossbar 920 may perform selective connection of the ports 910 under control of routing and arbitration logic within the network router 900. For unicast packets addressed to a single destination, the crossbar 920 may establish a connection from the input port where the packet arrived to the single output port leading toward the packet's destination. For multicast packets addressed to multiple destinations, the crossbar 920 may establish connections from the input port to multiple output ports simultaneously or sequentially, enabling the packet to be replicated and forwarded to all indicated destinations. The selection of which output ports to connect may be determined by examining the destination address (for unicast packets) or the destination bit-vector (for multicast packets) included in the packet header.

For example, the crossbar 920 may be implemented as a full crossbar (also termed a full mesh or non-blocking crossbar). A full crossbar may comprise a matrix of switching elements, with one switching element at each intersection of an input line and an output line. Each switching element may be controlled independently, allowing any input to connect to any output. For a router with N bidirectional ports, a full crossbar may comprise N×N switching elements (or N×N minus diagonal elements if self-connections are not needed). The full crossbar implementation may provide maximum flexibility and non-blocking operation, but may consume significant silicon area for high-radix routers.

In some examples, the crossbar 920 may be implemented as a multiplexer-based crossbar. In this implementation, each output port may have an associated multiplexer that selects among all input ports. For N ports, each output may have an N-to-1 multiplexer, and N such multiplexers may be required for the complete crossbar. The multiplexer select signals may be driven by arbitration logic that determines which input port is granted access to each output port in each cycle. The multiplexer-based implementation may be efficient for moderate port counts and may be straightforward to implement using standard cell libraries.

In some implementations, the crossbar 920 may be implemented as a buffered crossbar. A buffered crossbar may include small buffer memories at the crosspoint switching elements or at the outputs of the crossbar. The buffers may decouple input and output timing, may reduce head-of-line blocking, and may improve throughput under heavy traffic loads. The buffered crossbar implementation may increase latency slightly due to the additional buffering stage, but may provide higher sustained throughput compared to unbuffered designs.

In some examples, the crossbar 920 may be implemented as a pipelined crossbar. A pipelined crossbar may divide the switching operation into multiple pipeline stages, with registers between stages. Pipelining may enable higher clock frequencies by reducing the critical path through the crossbar, at the cost of increased latency measured in clock cycles. The pipelined implementation may be beneficial for high-performance designs where clock frequency is a primary constraint.

In some examples, the crossbar 920 may be implemented as a partial crossbar or hierarchical crossbar. A partial crossbar may not provide full connectivity between all input-output pairs, but may instead provide connectivity based on expected traffic patterns. A hierarchical crossbar may decompose the large crossbar into smaller sub-crossbars organized in multiple stages. These implementations may reduce area and power consumption for very high-radix routers where a full crossbar would be prohibitively expensive.

The crossbar 920 may support multicast operation by enabling a single input port to connect to multiple output ports simultaneously or in rapid succession. For simultaneous multicast, the crossbar 920 may include fan-out capability at each input, allowing the input data to be driven to multiple outputs in the same clock cycle. For sequential multicast, the crossbar 920 may establish connections to each output port one at a time over multiple cycles, with the multicast circuitry 930 controlling the sequence of connections. The choice between simultaneous and sequential multicast may depend on the crossbar implementation and the tradeoff between latency (simultaneous is faster) and hardware complexity (sequential is simpler).

The router 900 further comprises a multicast circuitry 930 coupled to the ports 910 and the crossbar 920. The multicast circuitry 930 may be a dedicated hardware block within the network router 900 that handles multicast packet processing, including determining which output ports should receive copies of a multicast packet and controlling the crossbar 920 to perform the necessary packet replication. The multicast circuitry 930 may be coupled to the ports 910 to receive incoming multicast packets and to access the destination bit-vector included in those packets. The multicast circuitry 930 may be connected to the input buffers of the bidirectional ports 910 to read packet headers and extract the destination bit-vector when a multicast packet arrives. The multicast circuitry 930 may also monitor flow control signals (such as credit availability) from the output ports to determine whether each port is ready to accept a packet.

The multicast circuitry 930 may be coupled to the crossbar 920 to control the switching connections for multicast packet forwarding. The multicast circuitry 930 may generate control signals that configure the crossbar 920 to connect the input port where the multicast packet arrived to one or more output ports where the packet should be forwarded. The multicast circuitry 930 may be implemented as a dedicated, parallel hardware path (also termed a “multicast engine”) within the router's microarchitecture. This dedicated path may handle multicast replication logic separately from the normal data path used for unicast packets, providing greater efficiency for multicast operations.

For example, the multicast circuitry 930 may be implemented as combinational logic. A combinational logic implementation may comprise logic gates, multiplexers, and comparators that examine the destination bit-vector and generate crossbar control signals in a single clock cycle or a fixed small number of cycles. The combinational logic implementation may provide low latency for multicast processing.

In some examples, the multicast circuitry 930 may be implemented as a finite state machine (FSM). The FSM may be configured to control the crossbar 920 based on the destination bit-vector by sequencing through states that examine different portions of the bit-vector, configure the crossbar for each destination port, and manage the transfer of the packet to each destination. For example, the FSM may transition through states such as IDLE, PARSE_BIT_VECTOR, LOCAL_DELIVERY, SPINE_FORWARD, and COMPLETE. The multicast circuitry 930 may also be implemented as a combination of combinational logic and finite state machine elements, balancing the low latency of combinational logic with the flexibility of state machine design.

The multicast circuitry 930 is configured to receive a packet including a multicast destination bit-vector from a source port of the plurality of ports. The multicast destination bit-vector may be a data structure included in the packet that identifies which endpoint ports in the hierarchical fabric should receive copies of the multicast packet. As described previously in connection with FIG. 1 and FIG. 8, the destination bit-vector may comprise a plurality of bits, wherein each bit corresponds to a specific endpoint port in the hierarchical fabric, and wherein a set bit (for example, a bit value of ‘1’) indicates that the corresponding endpoint port is a destination for the multicast operation.

The packet including the destination bit-vector may arrive at the network router 900 from various sources depending on the packet's path through the hierarchical fabric. For example, the packet may arrive from a local endpoint interface connected to one of the bidirectional ports 910, where an instance of the apparatus 100 (BF-PAC) has generated the multicast packet and injected it into the network router 900, as described in connection with FIG. 6 (step 1). Alternatively, the packet may arrive from a higher-tier router (spine router) that has forwarded the packet as part of the multicast distribution process, as described in connection with FIG. 6 (step 3 to step 4). In either case, the source port from which the packet arrives may be one of the bidirectional ports 910 of the network router 900.

The destination bit-vector may be included in the packet header or in a dedicated field within the packet structure. The packetization circuitry 124 within the apparatus 100 may insert the destination bit-vector into the packet during packet formation, as described previously in connection with FIG. 7. The destination bit-vector may travel with the packet as it traverses through the hierarchical fabric, enabling each router along the path to examine the bit-vector and determine its role in the multicast distribution. For example, the destination bit-vector may enable distributed multicast processing within the hierarchical fabric. Rather than requiring a centralized controller to coordinate multicast distribution, each router may independently examine the destination bit-vector and determine which of its output ports should receive copies of the packet. This distributed approach may scale efficiently to large networks and may avoid bottlenecks associated with centralized control. The multicast circuitry 930 is further configured to control the crossbar to replicate the packet to one or more of the local endpoint interfaces based on the destination bit-vector. When the multicast circuitry 930 receives a multicast packet, it may examine the destination bit-vector to identify which local endpoint interfaces (connected to the bidirectional ports 910 of this router) are destinations for the multicast. For each local endpoint interface that is indicated as a destination, the multicast circuitry 930 may configure the crossbar 920 to establish a connection from the source port (where the packet arrived) to the output port connected to that local endpoint interface. The packet may then be transferred through the crossbar 920 to the destination port, and from there to the local endpoint interface.

If multiple local endpoint interfaces are indicated as destinations in the destination bit-vector, the multicast circuitry 930 may control the crossbar 920 to replicate the packet to each of those interfaces. Replication may be performed simultaneously (if the crossbar 920 supports fan-out from one input to multiple outputs) or sequentially (if the crossbar 920 establishes connections one at a time). In either case, each indicated local endpoint interface may receive a copy of the multicast packet.

The destination bit-vector may comprise a first portion of bits corresponding to the local endpoint interfaces and a second portion of bits corresponding to non-local destinations. The first portion of bits may represent the endpoint interfaces that are directly connected to the bidirectional ports 910 of this network router 900. The second portion of bits may represent endpoint interfaces that are connected to other routers in the hierarchical fabric and are reachable only via the higher-tier routers (spine routers).

The organization of the destination bit-vector into portions corresponding to different routers may follow a structured mapping based on router identifiers and port numbering within the hierarchical fabric. For example, in a fat-tree topology with 16 leaf routers each having 8 local endpoint ports, the 128-bit destination bit-vector may be divided into 16 portions of 8 bits each. Each 8-bit portion may correspond to the local ports of one leaf router. For the network router 900 with a particular router identifier (for example, router identifier 4), the first portion of bits relevant to this router may be bits 32 through 39 of the destination bit-vector (assuming router 4 owns ports 32-39 in the global port numbering). The second portion of bits corresponding to non-local destinations may be the remaining bits of the destination bit-vector (bits 0-31 and bits 40-127), representing ports on other leaf routers.

The multicast circuitry 930 may be configured to control the crossbar 920 to replicate the packet based on the first portion of the destination bit-vector. The multicast circuitry 930 may extract the first portion of bits from the destination bit-vector by applying a mask or by selecting the appropriate bit range based on the router's identifier. Each set bit within the first portion may indicate a local port that should receive the multicast packet. The multicast circuitry 930 may iterate through the first portion, and for each set bit, may configure the crossbar 920 to connect the source port to the corresponding local output port.

The multicast circuitry 930 may be further configured to generate a masked bit-vector based on the second portion of the destination bit-vector. The masked bit-vector may be a modified version of the destination bit-vector that is forwarded to higher-tier routers for continued multicast distribution. The generation of the masked bit-vector and forwarding to higher-tier routers will be described in further detail below.

The multicast circuitry 930 is further configured to generate a masked bit-vector based on the destination bit-vector that indicates one or more non-local destinations reachable only via the at least one higher-tier router. The masked bit-vector may be a modified version of the original destination bit-vector that is prepared for forwarding to a higher-tier router (spine router) to continue the multicast distribution to destinations beyond the local network router 900.

Non-local destinations may be endpoint interfaces that are not directly connected to the bidirectional ports 910 of the network router 900, but are instead connected to other leaf routers in the hierarchical fabric. Since the network router 900 (as a leaf router) does not have direct connections to these non-local endpoints, packets destined for non-local endpoints must traverse through at least one higher-tier router (spine router) to reach the destination leaf router, and from there to the destination endpoint interface. The hierarchical structure of the fat-tree topology may require this multi-hop routing for communication between endpoints connected to different leaf routers.

The multicast circuitry 930 may examine the destination bit-vector to determine whether any non-local destinations are indicated. As described previously, the destination bit-vector may comprise a first portion of bits corresponding to local endpoint interfaces and a second portion of bits corresponding to non-local destinations. If any bits in the second portion are set, this may indicate that the multicast packet needs to be forwarded to a higher-tier router for distribution to those non-local destinations.

The multicast circuitry 930 may generate the masked bit-vector to convey information about the remaining destinations to the higher-tier router. The masked bit-vector may indicate which endpoints still need to receive the multicast packet after the local deliveries have been performed by the current router. The higher-tier router may use this masked bit-vector to determine which other leaf routers should receive copies of the multicast packet.

For example, generating the masked bit-vector may comprise clearing the first portion of bits in the destination bit-vector. Clearing the first portion of bits may involve setting the bits corresponding to the local endpoint interfaces of the network router 900 to zero, while preserving the bits corresponding to non-local destinations. This bitwise clearing operation may create a new vector for the spine router by zeroing out the block of bits that corresponds to the router's own local ports. The clearing operation may be performed using combinational logic within the multicast circuitry 930. For example, the multicast circuitry 930 may generate a bitmask that has zeros in the bit positions corresponding to local ports and ones in all other positions. The multicast circuitry 930 may then perform a bitwise AND operation between the original destination bit-vector and this bitmask, producing the masked bit-vector with the local port bits cleared. For example, if the network router 900 is router 4 with local ports corresponding to bits 32-39, the bitmask may have zeros in bit positions 32-39 and ones in all other positions. The AND operation may clear bits 32-39 while preserving the values of all other bits.

The clearing the local port bits may prevent the higher-tier router from unnecessarily returning the multicast packet back to the network router 900. Since the network router 900 has already handled delivery to its local endpoints, the cleared bits may inform the higher-tier router that no further delivery to those endpoints is required. This may avoid duplicate packet delivery and may prevent routing loops where a packet circulates between a leaf router and spine router without making progress.

The masked bit-vector may also provide information to the higher-tier router about which leaf routers need to receive the multicast packet. The higher-tier router may examine the masked bit-vector and may identify which portions of the bit-vector have set bits, indicating which leaf routers have destination endpoints for the multicast. The higher-tier router may then replicate the packet and forward copies to those leaf routers, as will be described in further detail in connection with the spine router operation.

The multicast circuitry 930 is further configured to forward the packet with the masked bit-vector toward the at least one higher-tier router only when the masked bit-vector is non-zero. After generating the masked bit-vector by clearing the local port bits as described above, the multicast circuitry 930 may evaluate whether any bits remain set in the masked bit-vector. A non-zero masked bit-vector may indicate that one or more non-local destinations exist that require the multicast packet to be forwarded through a higher-tier router (spine router) for continued distribution. The multicast circuitry 930 may perform a check to determine whether the masked bit-vector is non-zero. For example, the multicast circuitry 930 may include an OR-reduction circuit that computes the logical OR of all bits in the masked bit-vector. If the result is ‘1’, at least one bit is set and the masked bit-vector is non-zero. If the result is ‘0’, all bits are cleared and the masked bit-vector is zero, indicating no non-local destinations remain.

When the masked bit-vector is non-zero, the multicast circuitry 930 may control the crossbar 920 to forward the multicast packet toward one of the higher-tier routers connected to the bidirectional ports 910. The forwarded packet may include the masked bit-vector (rather than the original destination bit-vector), so that the higher-tier router receives accurate information about which destinations still require packet delivery. The higher-tier router may then use this masked bit-vector to determine which leaf routers should receive copies of the multicast packet. When the masked bit-vector is zero, the multicast circuitry 930 may not forward the packet to any higher-tier router. A zero masked bit-vector may indicate that all destinations for the multicast packet are local to the network router 900 and have already been served through local delivery. Forwarding a packet with a zero masked bit-vector would be unnecessary and would waste network bandwidth, as no further distribution would be required. By suppressing forwarding when the masked bit-vector is zero, the multicast circuitry 930 may optimize network utilization and may avoid unnecessary traffic through the spine layer. The selection of which higher-tier router to forward the packet to, and the handling of flow control and adaptive routing, will be described in further detail below.

The multicast circuitry 930 may be further configured to select a target higher-tier router from the at least one higher-tier router based on a mapping between an identifier of the network router 900 and the at least one higher-tier router. The network router 900 may be connected to multiple higher-tier routers (spine routers) through different bidirectional ports 910, providing multiple possible paths for forwarding multicast packets to non-local destinations. The multicast circuitry 930 may use a predetermined mapping to select a default or primary higher-tier router for forwarding.

The mapping may be implemented as a fixed rule based on the router identifier. For example, in a fat-tree topology with 16 leaf routers (routers 0.0 through 0.15) and 8 spine routers (routers 1.0 through 1.7), leaf routers 0.0 through 0.7 may be mapped to spine routers 1.0 through 1.7 respectively, while leaf routers 0.8 through 0.15 may be mapped to spine routers 1.0 through 1.7 by computing the leaf router identifier minus 8. The network router 900 may use its own identifier to determine which specific higher-tier router it should forward non-local multicast packets to. This fixed rule approach may be implemented using simple arithmetic logic within the multicast circuitry 930, requiring minimal hardware resources while providing deterministic path selection.

In some examples, the mapping may be implemented as a pre-programmed lookup table within the multicast circuitry 930. The lookup table may store, for each leaf router identifier, the corresponding target spine router port. This programmable approach may provide flexibility to optimize traffic distribution or to adapt to different network configurations. The lookup table may be implemented using registers or memory elements that can be configured by system software, allowing the mapping to be changed without modifying the hardware. The lookup table approach may also support more complex mapping schemes that take into account factors such as load balancing, fault tolerance, or quality-of-service requirements.

The multicast circuitry 930 may be further configured to implement adaptive routing by selecting an alternative higher-tier router if the target higher-tier router has no available credits. Flow control credits may be signals exchanged between routers to indicate buffer availability at the receiving router. When a higher-tier router has available buffer space to accept a packet, it may provide credits to the network router 900. When the buffer becomes full, the higher-tier router may withhold credits, signaling that it cannot currently accept additional packets. The multicast circuitry 930 may monitor the credit status of each higher-tier router connected to the network router 900 to make informed forwarding decisions.

If the multicast circuitry 930 determines that the target higher-tier router (selected based on the mapping) has no available credits, the multicast circuitry 930 may dynamically select an alternative higher-tier router that does have available credits. This adaptive routing technique may redirect the packet to a non-congested path, avoiding delays associated with waiting for the congested path to become available. The dynamic path selection may be performed in hardware by the multicast circuitry 930 without requiring software intervention, enabling rapid response to changing network conditions.

For example, if the default mapping indicates spine router 1.3 as the target, but spine router 1.3 has no available credits, the multicast circuitry 930 may incrementally check other spine router ports (such as 1.4, 1.5, 1.6, 1.7, then wrapping to 1.0, 1.1, 1.2) until a spine router with available credits is found. The packet may then be forwarded to this alternative spine router. Since any spine router in a fat-tree topology can provide connectivity between any pair of leaf routers, the choice of which spine router to use does not affect the ability to reach the destination, only the path taken. The multicast circuitry 930 may exploit this path diversity to avoid congestion hotspots and to improve overall network throughput. Adaptive routing may be particularly beneficial under heavy traffic loads or when certain paths experience temporary congestion due to bursty traffic patterns, as the multicast circuitry 930 may automatically distribute traffic across available paths to maximize network utilization.

The network router 900 may enable efficient hardware-accelerated multicast distribution within a hierarchical fabric by providing dedicated multicast circuitry 930 that operates in parallel with normal unicast packet processing. The multicast circuitry 930 may allow the network router 900 to examine the destination bit-vector included in multicast packets and to independently determine which local endpoint interfaces and which higher-tier routers should receive copies of the packet, enabling distributed multicast processing without requiring centralized coordination or pre-configured routing state at each hop. The crossbar 920 controlled by the multicast circuitry 930 may provide flexible packet replication to multiple local endpoint interfaces simultaneously or sequentially, supporting efficient fan-out at each routing stage. The generation of masked bit-vectors by clearing local port bits may allow the network router 900 to communicate accurate destination information to higher-tier routers, preventing duplicate deliveries and avoiding routing loops. The conditional forwarding mechanism that forwards packets to higher-tier routers only when the masked bit-vector is non-zero may optimize network bandwidth utilization by suppressing unnecessary traffic when all destinations are local. The adaptive routing capability may provide resilience against network congestion by dynamically selecting alternative higher-tier routers when the primary path is blocked, improving overall throughput and reducing latency under heavy traffic conditions. The ability to receive pre-masked packets from higher-tier routers and perform only final local delivery may simplify router logic and may enable efficient division of multicast processing responsibilities across the hierarchical fabric. These features may be particularly beneficial for high-performance computing and artificial intelligence workloads that rely heavily on multicast communication patterns across scalable, glueless multi-chiplet systems.

The multicast circuitry 930 may be further configured to, upon receiving a second packet including a second, pre-masked destination bit-vector from a higher-tier router, control the crossbar 920 to replicate the second packet only to one or more of the local endpoint interfaces indicated by the second destination bit-vector. In some examples, the behavior may correspond to the operation of a destination leaf router that receives a multicast packet from a spine router as part of the multicast distribution process, as described in connection with FIG. 6 (step 4).

When a higher-tier router (e.g., a spine router) forwards a multicast packet to the network router 900, the spine router may have already generated a pre-masked destination bit-vector that includes only the bits corresponding to this network router's local ports. The spine router may perform this masking operation before forwarding, extracting only the relevant portion of the original destination bit-vector that pertains to the destination leaf router. This pre-masked destination bit-vector may indicate precisely which local endpoint interfaces on the network router 900 should receive the multicast packet, with all bits corresponding to other leaf routers' ports already cleared by the spine router.

Upon receiving such a pre-masked packet, the multicast circuitry 930 may perform only local delivery operations. The multicast circuitry 930 may examine the pre-masked destination bit-vector, may identify which local ports have set bits, and may control the crossbar 920 to replicate the packet to each of those local endpoint interfaces. The multicast circuitry 930 may not need to generate a new masked bit-vector or forward the packet to any higher-tier router, because the pre-masked bit-vector contains only local port information and has no bits set for non-local destinations.

This technique may be described as performing the final fan-out at the destination. The network router 900, acting as a destination leaf router, receives the packet with an already-masked vector and performs only the final local delivery to the ports indicated in that mask. This approach may simplify the logic required at destination leaf routers and may reduce processing latency for the final delivery stage.

For example, consider a multicast operation where the original 128-bit destination bit-vector has bits set for ports 8, 9, 14, 35, and 72, indicating five destination endpoints across the hierarchical fabric. The multicast packet may originate at a source leaf router (for example, router 0.4), which delivers locally and forwards the packet to a spine router. The spine router may determine that ports 8, 9, and 14 belong to leaf router 0.1 (which owns ports 8-15), port 35 belongs to leaf router 0.4 (already served), and port 72 belongs to leaf router 0.9 (which owns ports 72-79). When the spine router forwards the packet to leaf router 0.1 (the network router 900 in this example), it may generate a pre-masked bit-vector with only bits 8, 9, and 14 set, and all other bits cleared. The network router 900 may receive this pre-masked packet, examine the bit-vector, identify that local ports 8, 9, and 14 (corresponding to ports 0, 1, and 6 in the router's local port numbering) should receive the packet, and may control the crossbar 920 to replicate the packet to these three local endpoint interfaces. The network router 900 does not need to forward the packet further, as the pre-masked bit-vector contains no indication of non-local destinations.

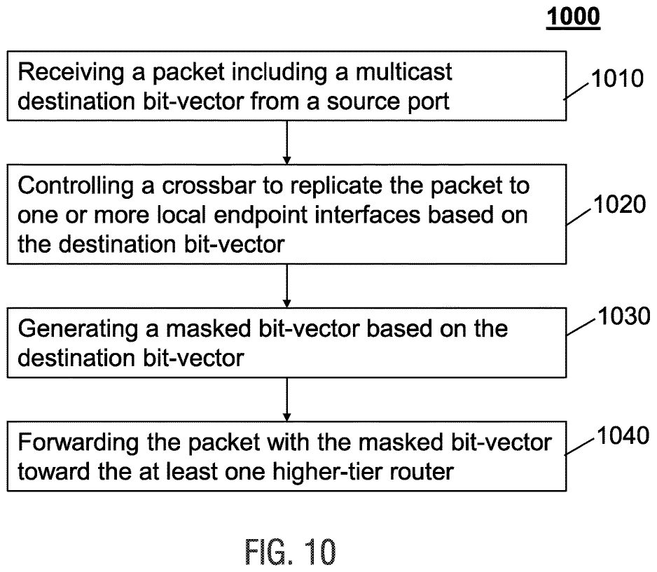

Further details and aspects are mentioned in connection with the examples described above or below. The example shown in FIG. 9 may include one or more optional additional features corresponding to one or more aspects mentioned in connection with the proposed concept or one or more examples described above (e.g., FIGS. 1-8) or below (e.g., FIGS. 10-17).

FIG. 10 illustrates a method 1000 for network routing. The method 1000 may, for instance, be performed by an apparatus as described herein, such as apparatus 900. The method 1000 comprises receiving 1010 a packet including a multicast destination bit-vector from a source port of a plurality of bidirectional ports. The method 1000 further comprises controlling 1020 a crossbar to replicate the packet to one or more local endpoint interfaces based on the destination bit-vector. The method further 1000 comprises generating 1030 a masked bit-vector based on the destination bit-vector that indicates one or more non-local destinations reachable only via at least one higher-tier router. The method further 1000 comprises forwarding 1040 the packet with the masked bit-vector toward the at least one higher-tier router only when the masked bit-vector is non-zero.

Further details and aspects are mentioned in connection with the examples described above or below. The example shown in FIG. 10 may include one or more optional additional features corresponding to one or more aspects mentioned in connection with the proposed concept or one or more examples described above (e.g., FIGS. 1-9) or below (e.g., FIGS. 11-17).

### Spine Router

FIG. 11 illustrates a network router 1100. For example, the router 1100 described with reference to FIG. 11 may incorporate elements, components, and concepts that have been described above with reference to FIGS. 1 to 10. The terminology, definitions, and technical details established in the preceding descriptions may apply equally to the router 1100 unless explicitly stated otherwise. For example an on-die network router 1100 for a hierarchical fabric. The network router 1100 may be a hardware component within the hierarchical fabric that receives packets from lower-tier routers, determines the appropriate lower-tier routers to forward those packets to based on multicast destination information, and distributes the packets toward their ultimate destinations. The network router 1100 may serve as an interconnection point in the network-on-chip infrastructure, providing connectivity between multiple lower-tier routers.

As described previously in connection with FIG. 9, an on-die network router may be a router that is implemented on the same semiconductor die as other components of the chiplet, enabling high bandwidth, low latency communication and tight integration. The network router 1100 may be part of a hierarchical fabric, which may be a network topology organized in multiple tiers or levels of routing elements, as described in connection with FIG. 1 through FIG. 9.

The hierarchical fabric may implement a fat-tree topology, wherein the network comprises multiple levels of routers arranged in a tree-like structure with high bisection bandwidth. In a fat-tree topology, the network router 1100 may be a spine router positioned at a higher tier of the hierarchy. The spine router may interconnect multiple leaf routers positioned at lower tiers, providing paths for communication between endpoints connected to different leaf routers. The plurality of lower-tier routers connected to the network router 1100 may be leaf routers of the fat-tree topology, such as the leaf routers 410 (L0 North) and 430 (L0 South) described in connection with FIG. 4.

In the context of the chiplet network architecture described in connection with FIG. 4, the network router 1100 may correspond to one of the spine routers 420 (L1 Spine) shown in that figure. The network router 1100 may be positioned in the middle tier of the three-tier fat-tree structure, with connections to multiple leaf routers above and below. The spine router may not connect directly to endpoint interfaces (such as compute cores or memory), but may instead focus on forwarding traffic between leaf routers based on routing information included in the packets.

The network router 1100 may be configured to handle multicast packets that require distribution to multiple leaf routers simultaneously. For multicast operations, the network router 1100 may include specialized multicast circuitry that examines the destination bit-vector received from a source leaf router, determines which other leaf routers need to receive the multicast packet, generates appropriate masked bit-vectors for each target leaf router, and coordinates the replication and distribution of packets to all indicated destinations, as described in connection with the multicast flow shown in FIG. 6 (step 3).

The router 1100 comprises a plurality of bidirectional ports 1110 configured for connection to a plurality of lower-tier routers. As described previously in connection with FIG. 9, the bidirectional ports 1110 may be the physical and logical interfaces through which the network router 1100 communicates with other components in the hierarchical fabric. Each bidirectional port 1110 may support both incoming traffic (packets arriving at the router) and outgoing traffic (packets departing from the router), enabling full-duplex communication in both directions simultaneously.

For example, the bidirectional ports 1110 may be arranged around the periphery of the network router 1100 and may be implemented as a combination of input and output interface logic, including input buffers, output buffers, arbitration logic, flow control logic, and driver circuitry, as described previously. For example, in a 16×16 router implementation as shown in FIG. 4, the network router 1100 may comprise 16 bidirectional ports 1110.

For example, the bidirectional ports 1110 of the network router 1100 may be configured for connection to a plurality of lower-tier routers. Lower-tier routers may be routers positioned at a lower level in the hierarchical fabric relative to the network router 1100. In the fat-tree topology, the lower-tier routers may be the leaf routers (such as network router 900 described in connection with FIG. 9) that connect directly to endpoint interfaces. The spine router (network router 1100) may occupy a higher tier in the hierarchy, positioned between the leaf routers and providing interconnection paths among them.

For example, in the three-tier fat-tree structure shown in FIG. 4, if the network router 1100 is one of the spine routers 420 (L1 Spine), the plurality of lower-tier routers may be the leaf routers 410 (L0 North) positioned above and the leaf routers 430 (L0 South) positioned below. Each bidirectional port 1110 of the spine router may connect to a corresponding port on one of the leaf routers, establishing the vertical connectivity within the fat-tree topology. In some examples, unlike the leaf router 900 which connects to both endpoint interfaces and higher-tier routers, the spine router (network router 1100) may connect exclusively to lower-tier routers through its bidirectional ports 1110. The spine router may not have direct connections to endpoints such as compute cores or memory interfaces, but may instead serve as a pure switching element within the network fabric, forwarding traffic between the leaf routers that are attached to endpoints.

The router 1100 further comprises a crossbar 1120 configured to selectively connect the ports. As described previously in connection with FIG. 9, the crossbar 1120 may be the central switching element within the network router 1100 that provides configurable connectivity between any input port and any output port. The crossbar 1120 may enable packets arriving on any of the bidirectional ports 1110 to be forwarded to any other of the bidirectional ports 1110 based on routing decisions made by the multicast circuitry 1130. The crossbar 1120 may support multicast operation by enabling a single input port to connect to multiple output ports, allowing packet replication from one source lower-tier router to multiple target lower-tier routers. The crossbar 1120 may be implemented using various configurations such as full crossbar, multiplexer-based crossbar, buffered crossbar, pipelined crossbar, or hierarchical crossbar, as described previously in connection with FIG. 9.

The router 1100 further comprises a multicast circuitry 1130 coupled to the ports and the crossbar. As described previously in connection with FIG. 9, the multicast circuitry 1130 may be a dedicated hardware block within the network router 1100 that handles multicast packet processing. The multicast circuitry 1130 may be coupled to the ports 1110 to receive incoming multicast packets from lower-tier routers and may be coupled to the crossbar 1120 to control the switching connections for multicast packet distribution. For example, the multicast circuitry 1130 may be implemented as a dedicated, parallel hardware path (multicast engine) within the router's microarchitecture. For example, the multicast circuitry 1130 may be implemented as combinational logic comprising logic gates, multiplexers, and comparators that examine the destination bit-vector and generate crossbar control signals. Alternatively, the multicast circuitry 1130 may be implemented as a finite state machine (FSM) that sequences through states to process the multicast distribution operation, such as states for receiving packets, determining target routers, generating masked bit-vectors, and controlling packet replication. The multicast circuitry 1130 may also be implemented as a combination of combinational logic and finite state machine elements, as described previously in connection with FIG. 9

The multicast circuitry 1130 is configured to receive a packet including a first multicast destination bit-vector from a source lower-tier router. The packet may be a multicast packet that has been forwarded from a leaf router to the spine router as part of the multicast distribution process. As described in connection with FIG. 6 (step 2), when a leaf router receives a multicast packet and determines that non-local destinations exist (indicated by a non-zero masked bit-vector), the leaf router may forward the packet with the masked bit-vector to a spine router for continued distribution.

The first multicast destination bit-vector may be the destination bit-vector included in the packet as received from the source lower-tier router. The first multicast destination bit-vector may be distinguished form a second masked bit-vectors that the multicast circuitry 1130 will subsequently generate for each target lower-tier router, as will be described below. The first destination bit-vector may identify which endpoint ports across the hierarchical fabric should receive the multicast packet. As described previously, the destination bit-vector may comprise a plurality of bits, wherein each bit corresponds to a specific endpoint port in the hierarchical fabric.

The source lower-tier router may be one of the leaf routers connected to the bidirectional ports 1110 of the network router 1100. The source lower-tier router may be the leaf router that forwarded the multicast packet to the spine router because the packet has destinations on other leaf routers that are not directly reachable from the source leaf router. For example, in the scenario shown in FIG. 6, the source lower-tier router may be leaf router 0.4, which receives the multicast packet from a local endpoint, delivers to its local destination ports, and then forwards the packet with a masked bit-vector to spine router 1.3 (the network router 1100) for distribution to other leaf routers.

The multicast circuitry 1130 is further configured to determine, based on the first destination bit-vector, a set of target lower-tier routers to receive the packet. The multicast circuitry 1130 may examine the first destination bit-vector received from the source lower-tier router to identify which endpoint ports are destinations for the multicast. Since different endpoint ports are connected to different leaf routers in the hierarchical fabric, the multicast circuitry 1130 may determine which leaf routers have at least one destination endpoint by analyzing which portions of the destination bit-vector have set bits.

The destination bit-vector may be organized into portions corresponding to different leaf routers based on the port allocation scheme of the hierarchical fabric. For example, in a fat-tree topology with 16 leaf routers each having 8 local endpoint ports, the 128-bit destination bit-vector may be divided into 16 portions of 8 bits each. Bits 0-7 may correspond to the ports of leaf router 0.0, bits 8-15 may correspond to the ports of leaf router 0.1, bits 16-23 may correspond to the ports of leaf router 0.2, and so forth. The multicast circuitry 1130 may examine each 8-bit portion of the destination bit-vector, and if any bit within a portion is set, the corresponding leaf router may be identified as a target lower-tier router that needs to receive the multicast packet.

For example, if the first destination bit-vector has bits set at positions 8, 9, 14, 72, and 115, the multicast circuitry 1130 may determine that leaf router 0.1 (owning bits 8-15) has two destination ports, leaf router 0.9 (owning bits 72-79) has one destination port, and leaf router 0.14 (owning bits 112-119) has one destination port. These three leaf routers may constitute the set of target lower-tier routers.

For each of the target lower-tier routers, the multicast circuitry 1130 is further configured to generate a respective second, masked destination bit-vector. For each target leaf router identified in the previous step, the multicast circuitry 1130 may create a customized masked bit-vector that contains only the relevant destination information for that specific leaf router. Generating the respective second, masked destination bit-vector for each of the target lower-tier routers may comprise masking the first destination bit-vector to preserve only a portion of bits corresponding to endpoint interfaces of that target lower-tier router. This bit-vector filtering technique may extract the small block of bits that are relevant to each specific leaf router's local endpoints from the full destination bit-vector, while clearing all other bits.

For example, for each target leaf router, the multicast circuitry 1130 may generate a bitmask that has ones in the bit positions corresponding to that leaf router's ports and zeros in all other positions. The multicast circuitry 1130 may then perform a bitwise AND operation between the first destination bit-vector and this bitmask, producing a masked bit-vector specific to that target leaf router. For example, for leaf router 0.1 (which owns bits 8-15), the bitmask may have ones in bit positions 8-15 and zeros in all other positions. The AND operation between the first destination bit-vector (with bits 8, 9, 14, 72, and 115 set) and this mask may produce a second masked bit-vector with only bits 8 and 9 set (corresponding to the destinations on leaf router 0.1) and all other bits cleared to zero. Similarly, for leaf router 0.9 (which owns bits 72-79), a bitmask with ones in positions 72-79 and zeros elsewhere may be used, resulting in a masked bit-vector with only bit 72 set. For leaf router 0.14 (which owns bits 112-119), a bitmask with ones in positions 112-119 may produce a masked bit-vector with only bit 115 set.

These masked bit-vectors may enable each receiving leaf router to immediately identify its local destination ports without needing to parse the entire 128-bit destination bit-vector or determine which portion is relevant to it. The receiving leaf router may simply examine the masked bit-vector it receives, identify which bits are set, and deliver the packet to those local ports, as described in connection with FIG. 9 for handling pre-masked packets from higher-tier routers. This division of labor between the spine router (which performs the bit-vector filtering and generates appropriate masks) and the leaf routers (which perform only local delivery based on received masks) may simplify the logic at each router and may enable efficient distributed multicast processing.

The multicast circuitry 1130 is further configured to replicate the packet. Packet replication may be the creation of multiple copies of the multicast packet received from the source lower-tier router, wherein each copy is prepared for transmission to one of the target lower-tier routers identified in the previous step. Since the multicast operation requires the packet to be delivered to multiple leaf routers, the multicast circuitry 1130 may create as many copies of the packet as there are target lower-tier routers in the set. For example, if the multicast circuitry 1130 has determined that three target lower-tier routers (leaf routers 0.1, 0.9, and 0.14) need to receive the multicast packet, the multicast circuitry 1130 may replicate the packet to create three copies. Each replicated packet may include the payload data from the original packet, but may be associated with a different one of the second, masked destination bit-vectors generated for each target leaf router. The replicated packet for leaf router 0.1 may include the masked bit-vector with only bits 8 and 9 set, the replicated packet for leaf router 0.9 may include the masked bit-vector with only bit 72 set, and the replicated packet for leaf router 0.14 may include the masked bit-vector with only bit 115 set.

The multicast circuitry 1130 is further configured to control the crossbar to transmit a replicated packet with the respective second destination bit-vector to each of the target lower-tier routers. After replicating the packet and generating the appropriate masked bit-vectors for each target, the multicast circuitry 1130 may coordinate the actual transmission of the packets through the crossbar 1120 to the bidirectional ports 1110 connected to the target leaf routers. The multicast circuitry 1130 may control the crossbar 1120 by generating control signals that configure the switching connections. For each target lower-tier router, the multicast circuitry 1130 may identify which bidirectional port 1110 connects to that leaf router and may configure the crossbar 1120 to establish a connection from the input port (where the packet was received) to the output port leading to that target leaf router. The replicated packet transmitted through each connection may include the respective second, masked destination bit-vector that was generated specifically for that target leaf router.

In some examples, the multicast circuitry 1130 may be configured to transmit the replicated packets to the target lower-tier routers in parallel or serially. The choice between parallel and serial transmission may represent a configurable transmission scheduling approach with different design trade-offs. For parallel transmission, the multicast circuitry 1130 may control the crossbar 1120 to simultaneously establish connections to multiple output ports, sending all replicated packets in the same clock cycle or overlapping time periods. The crossbar 1120 may support fan-out capability, allowing the input port to drive multiple output ports concurrently. Parallel transmission may provide lower latency for multicast operations, as all target leaf routers receive their packets without waiting for sequential processing. However, parallel transmission may require more complex crossbar hardware to support simultaneous multi-output connections and may require higher instantaneous bandwidth.

For serial transmission, the multicast circuitry 1130 may control the crossbar 1120 to establish connections to output ports one at a time, sending replicated packets sequentially over multiple clock cycles. The multicast circuitry 1130 may iterate through the set of target lower-tier routers, configuring the crossbar 1120 for each target in turn, transmitting the packet with the appropriate masked bit-vector, and then moving to the next target. Serial transmission may save hardware area and complexity by reusing the same crossbar paths for each destination and by avoiding the need for simultaneous multi-output capability. However, serial transmission may increase latency, as later targets in the sequence must wait for earlier transmissions to complete.

For example, the multicast circuitry 1130 may implement a hybrid approach, wherein some packets are transmitted in parallel while others are transmitted serially based on available resources or priority levels. The choice between parallel and serial transmission may also depend on the number of target routers, with small fan-outs (few targets) using parallel transmission for speed and large fan-outs (many targets) using serial transmission to manage complexity.

For example, the transmission of the replicated packets may be based on available flow-control signals from the target lower-tier routers. Flow control may be a mechanism for preventing network overload by coordinating packet transmission with buffer availability at receiving routers. The multicast circuitry 1130 may not blindly transmit packets to target leaf routers, but may instead check flow-control signals to ensure that each destination is ready to receive the data before transmission occurs. The flow-control signals may be credit-based flow control signals. Each target lower-tier router may maintain a count of available buffer entries and may provide credits to the spine router (network router 1100) indicating how many packets can be accepted. When a leaf router has available buffer space, it may send a credit signal to the spine router. When the leaf router's buffers become full, it may withhold credits, signaling that it cannot currently accept additional packets. The multicast circuitry 1130 may monitor the credit status from each bidirectional port 1110 connected to target leaf routers.

For example, before transmitting a replicated packet to a target lower-tier router, the multicast circuitry 1130 may verify that the target has available credits. If a target leaf router has available credits, the multicast circuitry 1130 may proceed with transmission and may decrement the credit count for that target. If a target leaf router has no available credits, the multicast circuitry 1130 may delay transmission to that target until credits become available, preventing buffer overflow and packet loss.

For example, in the case of parallel transmission, the multicast circuitry 1130 may check credits for all target routers simultaneously. If all targets have available credits, all replicated packets may be transmitted in parallel. If some targets lack credits, the multicast circuitry 1130 may transmit only to those targets with available credits and may defer transmission to congested targets. In the case of serial transmission, the multicast circuitry 1130 may check credits for each target sequentially as it processes the transmission queue. This credit-based flow control may ensure reliable packet delivery and may prevent network congestion from propagating through the hierarchical fabric.

The network router 1100 may enable efficient multicast distribution across multiple lower-tier routers within a hierarchical fabric by providing dedicated multicast circuitry 1130 that coordinates packet replication and targeted delivery throughout the spine layer. The multicast circuitry 1130 may allow the network router 1100 to receive a multicast packet from a source leaf router, examine the destination bit-vector to determine which leaf routers require the packet, and generate customized masked bit-vectors for each target leaf router through bit-vector filtering, thereby simplifying the processing burden on destination leaf routers and enabling them to perform only final local delivery. The flexible transmission scheduling may provide design trade-offs between parallel transmission for lower latency and serial transmission for reduced hardware complexity, allowing the network router 1100 to be optimized based on system requirements and performance targets. The credit-based flow control coordination with multiple target lower-tier routers may prevent network congestion and buffer overflow by ensuring that packets are transmitted only to routers with available buffer space, improving reliability and preventing packet loss. The generation of respective masked bit-vectors for each target may eliminate the need for destination leaf routers to parse the full destination bit-vector or determine which portions are relevant, reducing processing latency at the destination and enabling efficient distributed multicast processing. The network router 1100 may support scalable multicast operations across glueless multi-chiplet systems by serving as the interconnection point between leaf routers attached to different chiplets or within different portions of a large-scale fat-tree topology, enabling seamless multicast distribution without requiring dedicated external switch devices or software coordination at intermediate hops. These features may be particularly beneficial for high-performance computing and artificial intelligence workloads that require efficient one-to-many communication patterns across distributed computing resources in chiplet-based architectures.

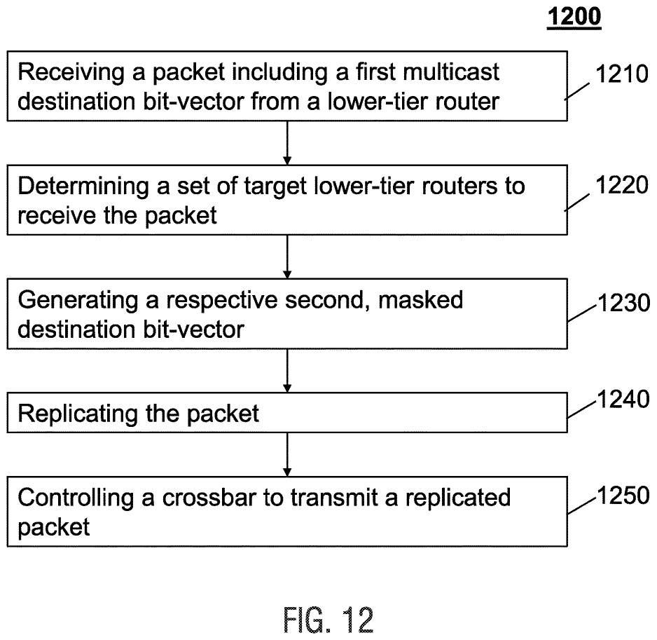

Further details and aspects are mentioned in connection with the examples described above or below. The example shown in FIG. 11 may include one or more optional additional features corresponding to one or more aspects mentioned in connection with the proposed concept or one or more examples described above (e.g., FIGS. 1-10) or below (e.g., FIGS. 12-17).

FIG. 12 illustrates a method 1200 for network routing. The method 1200 may, for instance, be performed by an apparatus as described herein, such as apparatus 100. The method 1200 comprises receiving 1210 a packet including a first multicast destination bit-vector from a source lower-tier router. The method 1200 further comprises determining 1220, based on the first destination bit-vector, a set of target lower-tier routers to receive the packet.

The method 1200 further comprises, for each of the target lower-tier routers, generating 1230 a respective second, masked destination bit-vector. The method 1200 further comprises replicating 1240 the packet. The method 1200 further comprises controlling 1250 a crossbar to transmit a replicated packet with the respective second destination bit-vector to each of the target lower-tier routers.

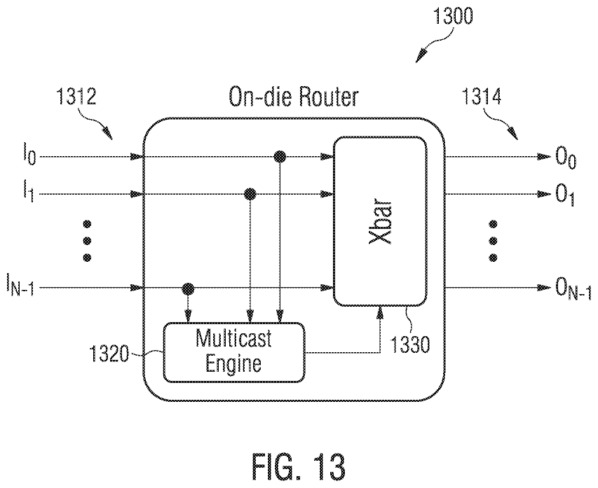

Further details and aspects are mentioned in connection with the examples described above or below. The example shown in FIG. 12 may include one or more optional additional features corresponding to one or more aspects mentioned in connection with the proposed concept or one or more examples described above (e.g., FIGS. 1-11) or below (e.g., FIGS. 13-17).

FIG. 13 illustrates an example router implementation 1300 for a hierarchical fabric. The router implementation 1300 may represent a on-die router design that can be configured as either a leaf router (such as network router 900 described in connection with FIG. 9) or a spine router (such as network router 1100 described in connection with FIG. 11). The router implementation 1300 may demonstrate the internal organization of router components and the dedicated hardware paths for handling multicast operations.

The NoC routers may require hardware dedicated to forwarding multicast requests through to the proper router ports to enable the multicasted packet to progress through the hierarchical fabric to the desired endpoints. The router implementation 1300 may include a dedicated path for multicast processing, adjacent to the port connectivity for read and write requests (unicast traffic). This separation of multicast processing from unicast processing may enable efficient parallel operation and may allow specialized logic optimized for each traffic type.

The router implementation 1300 comprises a plurality of input ports 1312, labeled as I₀, I₁, through I_{N−1}, where N may be the total number of ports supported by the router. The input ports 1312 may correspond to the input side of the bidirectional ports 910 (for a leaf router) or bidirectional ports 1110 (for a spine router) described previously. Each input port 1312 may receive packets arriving from connected endpoints (in the case of a leaf router) or from connected lower-tier or higher-tier routers (in the case of a leaf or spine router respectively). The router implementation 1300 further comprises a plurality of output ports 1314, labeled as O₀, O₁, through O_{N−1}. The output ports 1314 may correspond to the output side of the bidirectional ports and may transmit packets to their destinations after routing decisions have been made. The number of input ports 1312 and output ports 1314 may be equal, providing symmetric bidirectional connectivity for each physical port of the router.

The router implementation 1300 further comprises router multicast circuitry 1320, shown in blue, which may encompass the core switching and routing logic of the router. The multicast circuitry 1320 may include control logic, arbitration logic, buffering, and routing decision mechanisms for both unicast and multicast traffic. The multicast circuitry 1320 may interface with both the input ports 1312 and the output ports 1314.

The router implementation 1300 further comprises a crossbar (Xbar) positioned within or adjacent to the multicast circuitry 1320. The crossbar may correspond to the crossbar 920 (for a leaf router) or crossbar 1120 (for a spine router) described previously. The crossbar may provide the switching fabric that selectively connects input ports 1312 to output ports 1314 based on routing decisions.

The router implementation 1300 further comprises a multicast engine 1330, shown in a lighter color adjacent to the multicast circuitry 1320. The multicast engine 1330 may correspond to the multicast circuitry 930 (for a leaf router) or multicast circuitry 1130 (for a spine router) described previously. The multicast engine 1330 may be positioned adjacent to the normal data path used for read and write (unicast) requests, providing a dedicated, parallel hardware path specifically designed to handle multicast replication logic separately from unicast processing.

The multicast engine 1330 may communicate with the output ports 1314 of the router via a connection to the crossbar. As shown in the figure, the multicast engine 1330 may have a dedicated port into the crossbar, allowing it to control crossbar switching connections for multicast packet distribution. When a multicast packet arrives at one of the input ports 1312, the packet may be routed to the multicast engine 1330 based on packet type indicators in the header. The multicast engine 1330 may examine the destination bit-vector included in the multicast packet, may determine which output ports 1314 should receive copies of the packet (for a leaf router: which local endpoint ports and which spine router ports; for a spine router: which target leaf router ports), and may control the crossbar to establish the necessary connections.

The dedicated interface between the multicast engine 1330 and the crossbar may enable the multicast engine to issue control commands independently of the unicast routing logic, allowing multicast and unicast traffic to be processed concurrently without contention for routing resources. The multicast engine 1330 may generate crossbar control signals that specify which input-to-output connections should be established, and may coordinate packet replication by either configuring the crossbar for simultaneous multi-output fan-out (parallel transmission) or by sequencing through multiple crossbar configurations (serial transmission), as described previously.

The router implementation 1300 may be scalable to different router radixes by varying the number N of input and output ports. For example, a 16×16 router implementation as described in connection with FIG. 4 may have N=16, providing 16 input ports 1312 and 16 output ports 1314. The multicast engine 1330 may be designed to handle destination bit-vectors of any length corresponding to the total number of endpoint ports in the hierarchical fabric, regardless of the specific radix of the individual router.

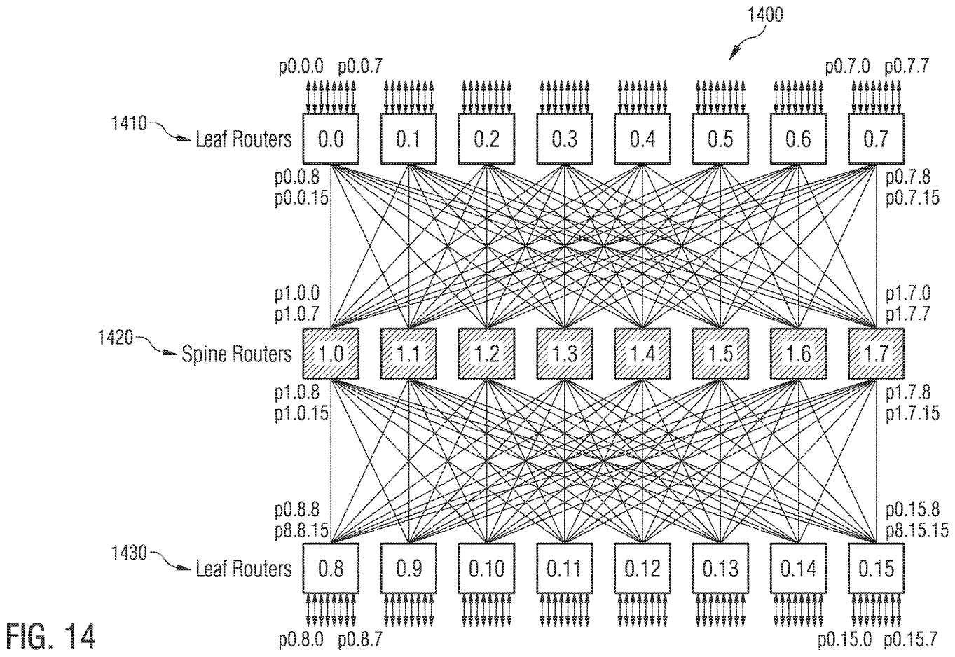

Further details and aspects are mentioned in connection with the examples described above or below. The example shown in FIG. 13 may include one or more optional additional features corresponding to one or more aspects mentioned in connection with the proposed concept or one or more examples described above (e.g., FIGS. 1-12) or below (e.g., FIGS. 14-17).

FIG. 14 illustrates a labeled diagram 1400 of a 2-level FatTree hierarchical fabric with router and port numbering. The diagram 1400 may provide a complete view of the router interconnection topology and may establish the naming conventions used to describe router and port identifiers throughout the hierarchical fabric. The labeling shown in this figure may be used to describe the expected behavior of the routers, including the leaf router operations described in connection with FIG. 9 and the spine router operations described in connection with FIG. 11.

The diagram 1400 comprises a first tier of leaf routers 1410 positioned at the top of the hierarchical fabric. The leaf routers 1410 may include eight routers labeled 0.0, 0.1, 0.2, 0.3, 0.4, 0.5, 0.6, and 0.7, shown in blue. Each leaf router in the first tier 1410 may have eight external ports (ports 0 through 7) connected to local endpoint interfaces, as indicated by the port symbols extending upward from each router. For example, leaf router 0.0 may have ports labeled p0.0.0 through p0.0.7, leaf router 0.1 may have ports labeled p0.1.0 through p0.1.7, and so forth. The port numbering convention may follow the format pX.Y.Z, where X indicates the tier (0 for leaf routers), Y indicates the router identifier within that tier, and Z indicates the specific port number on that router.

The diagram 1400 further comprises a second tier of spine routers 1420 positioned in the middle of the hierarchical fabric. The spine routers 1420 may include eight routers labeled 1.0, 1.1, 1.2, 1.3, 1.4, 1.5, 1.6, and 1.7, shown in green. Each spine router may have sixteen ports, with eight ports connected to the upper tier of leaf routers 1410 and eight ports connected to the lower tier of leaf routers 1430. For example, spine router 1.3 may have upper ports labeled p1.3.0 through p1.3.7 connecting to the upper leaf routers and lower ports labeled p1.3.8 through p1.3.15 connecting to the lower leaf routers.

The diagram 1400 further comprises a third tier of leaf routers 1430 positioned at the bottom of the hierarchical fabric. The leaf routers 1430 may include eight routers labeled 0.8, 0.9, 0.10, 0.11, 0.12, 0.13, 0.14, and 0.15, shown in blue. Each leaf router in the third tier 1430 may have eight external ports (ports 0 through 7) connected to local endpoint interfaces, as indicated by the port symbols extending downward from each router. For example, leaf router 0.8 may have ports labeled p0.8.0 through p0.8.7.

The interconnection pattern shown by the lines between routers may illustrate the fat-tree topology connectivity. Each leaf router may connect to all eight spine routers, and each spine router may connect to all sixteen leaf routers (eight from tier 1410 and eight from tier 1430). This fully connected bipartite graph between the leaf and spine tiers may provide multiple parallel paths between any pair of leaf routers, enabling high bisection bandwidth and supporting the multicast distribution operations described previously.

The total number of external endpoint ports in this hierarchical fabric may be 128 ports, calculated as 16 leaf routers×8 ports per leaf router. The global port numbering across the entire fabric may range from port 0 (p0.0.0 on leaf router 0.0) to port 127 (p0.15.7 on leaf router 0.15). This global port numbering may correspond to the bit positions in the 128-bit destination bit-vector used for multicast operations, wherein bit 0 represents port 0, bit 1 represents port 1, and so forth up to bit 127 representing port 127.

Implementing multicast operations in this hierarchical fabric may require specific behaviors to be supported by the NoC routers. The leaf routers 1410 and 1430 (such as network router 900) may determine, using the destination bit-vector, if any multicast targets are local NoC ports connected directly to the leaf router (ports 0-7 of that specific leaf router) and if any targets are NoC ports connected to other leaf routers. If local targets exist, the leaf router may deliver the packet to those local ports using its crossbar. If remote targets exist (indicated by a non-zero masked bit-vector after clearing local port bits), the multicast packet may be forwarded to one of the spine routers for continued distribution.

The spine routers 1420 (such as network router 1100) may determine which leaf routers to “cast” the message to, based on the target NoC ports indicated in the destination bit-vector. The spine router may examine the destination bit-vector received from a source leaf router, may identify which 8-bit portions of the bit-vector contain set bits (indicating which leaf routers have destinations), may generate respective masked bit-vectors for each target leaf router by preserving only the relevant 8-bit portion, and may replicate and transmit the packet with the appropriate masked bit-vector to each target leaf router.

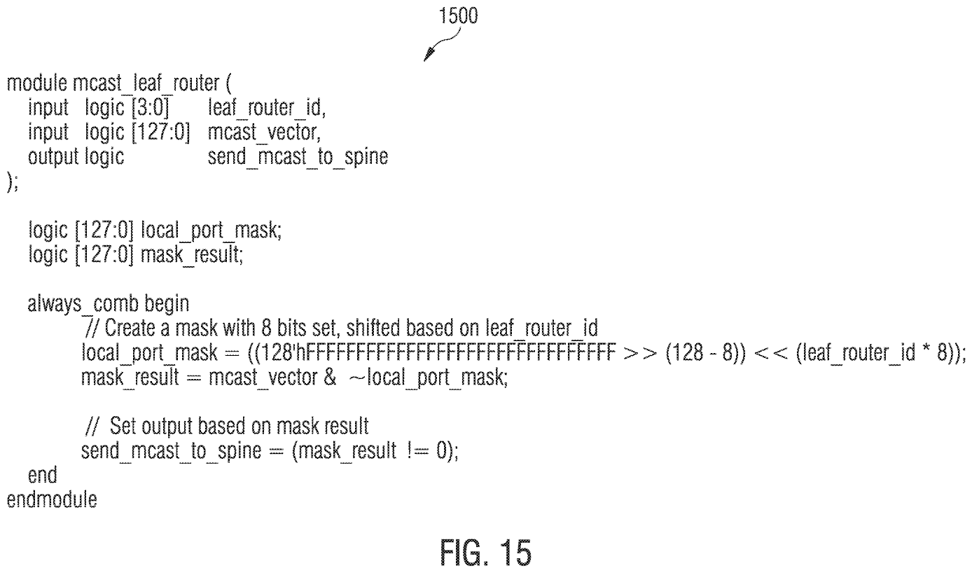

Further details and aspects are mentioned in connection with the examples described above or below. The example shown in FIG. 14 may include one or more optional additional features corresponding to one or more aspects mentioned in connection with the proposed concept or one or more examples described above (e.g., FIGS. 1-13) or below (e.g., FIGS. 15-17).

FIG. 15 illustrates example hardware description code 1500 for implementing leaf router multicast logic. The code 1500 may represent a Verilog implementation of the multicast circuitry 930 within the network router 900 (leaf router) described in connection with FIG. 9. The code may demonstrate how the leaf router determines which local endpoint ports should receive the multicast packet and whether the packet should be forwarded to a higher-tier router (spine router) for distribution to non-local destinations.

The behavior of the leaf router connected to the input port that receives the initial multicast request may involve taking in a destination bit-vector of target NoC ports and determining the router's output ports going to the target external NoC ports based on the current router's position in the NoC. The source-local leaf router multicast port determination method may follow a systematic approach based on bit-vector masking.

The code 1500 defines a module mcast_leaf_router with several signals. The input signal leaf_router_id may be a multi-bit identifier indicating the ID (i) of the current leaf router. For example, in the fat-tree topology shown in FIG. 14, the leaf_router_id may range from 0 to 15 for the 16 leaf routers. The input signal mcast_vector may be the 128-bit destination bit-vector (mcast [127:0]) included in the multicast packet. The output signal send_mcast_to_spine may be a Boolean signal indicating whether the multicast packet should be forwarded to a spine router.

Internal to the module, the code 1500 defines two logic signals: local_port_mask and mask_result, both 128 bits wide. These signals may implement the bit-vector masking operation described previously for generating the masked bit-vector. The code 1500 includes an always_comb begin block, which may define combinational logic that executes whenever the input signals change. The first operation in this block creates a bitmask with 8 bits set, shifted based on the leaf_router_id. The expression ((128′hFFFFFFFFFFFFFFFFFFFFFFFFFFFFFFFF>>(128−8))<<(leaf_router_id*8)) may generate the local_port_mask. This operation may first create a mask with the rightmost 8 bits set (by right-shifting a fully-set 128-bit value by 120 positions), and then may left-shift this 8-bit mask by (leaf_router_id×8) positions to align it with the current router's local port range.

For example, for leaf router 0.4 (with leaf_router_id=4), the local_port_mask may have bits 32-39 set (positions 4×8 through 4×8+7) and all other bits cleared. This mask may identify the portion of the destination bit-vector that corresponds to the local NoC ports of router 0.4. Given n (the number of external NoC ports provided by each leaf router, which is eight for this implementation) and i (the ID of the current router), the relevant portion for the current leaf router may be mcast [(i×n)−1:(i−1)×n]. The bits within this portion of the bit-vector may correspond to the leaf router's ports that are external NoC ports (ports 0 through 7 of that specific leaf router), and any asserted bits may indicate that the multicasted data will be forwarded to the corresponding local port.

The second operation computes mask_result=mcast_vector & ~local_port_mask. This operation may perform a bitwise AND between the mcast_vector and the inverted local_port_mask. The inversion (~local_port_mask) may create a mask with zeros in the local port positions and ones in all other positions. The AND operation may preserve only the bits corresponding to remote (non-local) NoC ports, effectively clearing the local port bits from the destination bit-vector. This mask_result may represent the masked bit-vector that would be forwarded to a spine router.

The final operation sets the output send_mcast_to_spine=(mask_result!=0). This comparison may check whether the mask_result is non-zero. If any bits remain set in the mask_result after clearing the local port bits, this may indicate that the multicast packet has destinations on other leaf routers that are not directly connected to the current leaf router. In this case, the multicast request may be forwarded to a spine router for continued distribution. If the mask_result is zero, all destinations may be local to this router, and no forwarding to a spine router may be necessary.

The port the multicast request arrived on should be excluded from the local delivery process, as the data should not be sent back to the source port. There may be a high likelihood that the input port's bit in the mcast_vector is asserted (given that the source endpoint is part of a pre-defined multicast group), and therefore the router may take specific action not to return the data to the requester. This source port exclusion may be implemented by additional logic (not shown in the code snippet) that prevents the crossbar from forwarding the packet back to the source port, as described in connection with FIG. 9. If the multicast is to be forwarded to a spine router (send_mcast_to_spine=true), the information sent to the spine router may include the masked mcast bit-vector (mask_result) to avoid the spine router returning the mcast request back to the current leaf router, and the ID of the multicast operation. The target spine router may be determined by mapping each leaf router ID to a corresponding spine router. For example, leaf routers 0-7 may forward to spine routers 0-7 respectively, while leaf routers 8-15 may forward to spine routers 0-7 (calculated as leaf router ID minus 8). Since any spine router can handle multicast operations, leaf routers may implement adaptive routing when the primary target spine router has no available credits, incrementally trying higher-numbered spine router ports until finding one with available credits, as described in connection with FIG. 9.

Once the multicast request arrives at the leaf routers connected to destination output ports, the behavior at these routers may follow that which was defined for the leaf routers connected to the source port. The router may forward the request to each port that has its corresponding bit in the received destination bit-vector asserted. The router may not send the request to any spine routers, as reflected in the received masked bit-vector not having any bits asserted outside of the local port portion. This behavior may correspond to the handling of pre-masked packets from higher-tier routers, as described in connection with FIG. 9, wherein the destination leaf router receives a packet with an already-masked vector and performs only the final local delivery to the ports indicated in that mask.

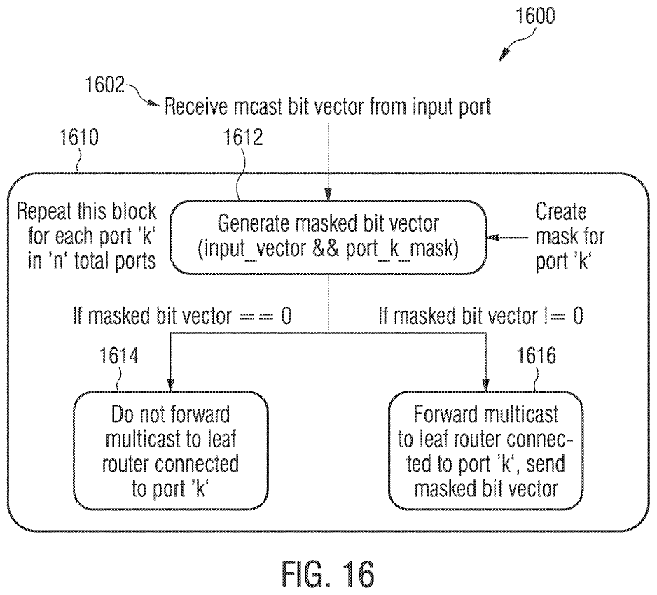

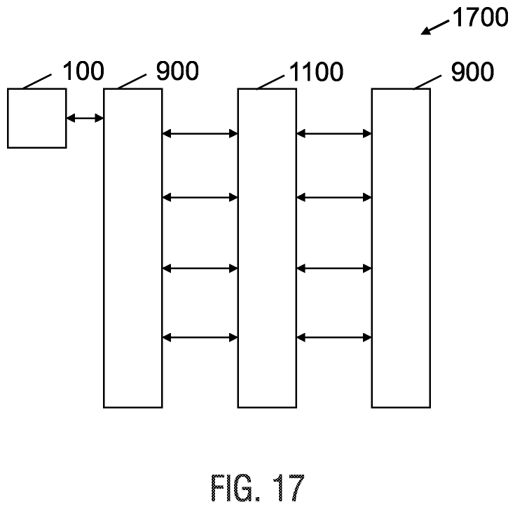

Further details and aspects are mentioned in connection with the examples described above or below. The example shown in FIG. 15 may include one or more optional additional features corresponding to one or more aspects mentioned in connection with the proposed concept or one or more examples described above (e.g., FIGS. 1-14) or below (e.g., FIGS. 16-17).

FIG. 16 illustrates a flow diagram 1600 for spine router multicast processing. The flow diagram 1600 may demonstrate the operational sequence performed by the multicast circuitry 1130 within the network router 1100 (spine router) described in connection with FIG. 11. The flow diagram 1600 may show how the spine router processes a multicast packet received from a source leaf router to determine target leaf routers and generate appropriate masked bit-vectors for distribution. Upon receipt of the multicast request packet from a source lower-tier router (leaf router), the spine router may take several steps to process and distribute the multicast. The spine router may parse the input destination bit-vector and determine all target leaf routers, may mask the destination bit-vector output to each target leaf router to preserve only the bit range corresponding to that leaf router's ports connected to NoC output ports, and may send unique packets with respective masked bit-vectors to the target ports.

The flow diagram 1600 begins at step 1602, labeled “Receive mcast bit vector from input port.” At this step, the multicast circuitry 1130 may receive the multicast packet including the first multicast destination bit-vector from the source lower-tier router, as described in connection with FIG. 11. The spine router may receive the 128-bit destination bit-vector as part of the multicast request packet forwarded from a leaf router. This received bit-vector may be the masked bit-vector that was generated by the source leaf router after clearing its own local port bits, as described in connection with FIG. 9.

The flow diagram 1600 proceeds to a repeated processing block 1610. This block 1610 may represent an iterative operation performed for each spine router port, denoted as port ‘k’ where k ranges from 0 to ‘n’−1, with ‘n’ being the total number of ports on the spine router. The label “Repeat this block for each port ‘k’ in ‘n’ total ports” may indicate that the processing within this region is executed for every bidirectional port 1110 of the spine router.

Within the repeated block 1610, the multicast circuitry 1130 may generate 1612 a masked bit-vector for port ‘k’ by performing the operation (input_vector && port_k_mask), shown in the blue processing block. The operation “Create mask for port ‘k” indicated on the right side may involve generating a bitmask that has ones in the bit positions corresponding to the leaf router connected to port k, and zeros in all other positions. For example, if port k connects to leaf router 0.1 (which owns global port positions 8-15), the port_k_mask may have ones in bit positions 8-15 and zeros elsewhere. The AND operation (&&) between the input_vector (the received destination bit-vector) and the port_k_mask may produce a masked bit-vector that preserves only the portion of bits corresponding to endpoint interfaces of that target lower-tier router.

Determination of the target leaf routers may be based on inspection of each region of the bit-vector corresponding to each leaf router's external NoC output ports. For each spine router port, a mask may be generated of only the bits in the destination bit-vector corresponding to the leaf router connected to the current port. This mask may be logically ANDed with the input destination bit-vector, and the resulting vector may be sent to the target leaf router if non-zero.

The flow diagram 1600 then branches based on whether the masked bit-vector is zero or non-zero. If the masked bit-vector equals zero (left branch), the flow proceeds to step 1614, labeled “Do not forward multicast to leaf router connected to port ‘k’.” This outcome may indicate that the leaf router connected to port k has no destination endpoints for this multicast operation, as evidenced by the absence of any set bits in the relevant portion of the destination bit-vector. In this case, the spine router may not transmit any packet to that leaf router, avoiding unnecessary network traffic.

If the masked bit-vector does not equal zero (right branch), the flow proceeds to step 1616, labeled “Forward multicast to leaf router connected to port ‘k’, send masked bit vector.” This outcome may indicate that the leaf router connected to port k has at least one destination endpoint, and therefore should receive a copy of the multicast packet. The spine router may control the crossbar 1120 to transmit a replicated packet with the respective second destination bit-vector (the masked bit-vector generated for port k) to the target lower-tier router connected to port k, as described in connection with FIG. 11.

Each port may be checked in parallel or serially, representing a design tradeoff. In a parallel implementation, the multicast circuitry 1130 may evaluate all ports simultaneously, generating masked bit-vectors for all ports in the same clock cycle and transmitting replicated packets to all target leaf routers concurrently. This approach may provide lower latency to issue all port requests but may require more complex hardware including larger crossbar structures and higher instantaneous bandwidth. In a serial implementation, the multicast circuitry 1130 may process ports sequentially, generating and evaluating the masked bit-vector for port 0, then port 1, and so forth, transmitting packets one at a time. This approach may reduce hardware area and router crossbar overheads but may increase the latency to complete the full multicast distribution.

The iterative nature of the processing block may be implemented using combinational logic that performs all operations in parallel, or using a finite state machine that sequences through the ports serially, or using a hybrid approach, as described in connection with the multicast circuitry implementation options in FIG. 11.

Further details and aspects are mentioned in connection with the examples described above or below. The example shown in FIG. 16 may include one or more optional additional features corresponding to one or more aspects mentioned in connection with the proposed concept or one or more examples described above (e.g., FIGS. 1-15) or below (e.g., FIGS. 15-17).

FIG. 17 illustrates a network-on-chip system 1700. The network-on-chip system 1700 comprises an ingress processing apparatus 100 as described above. The network-on-chip system 1700 further comprises a plurality of leaf routers 900 as described above. The network-on-chip system 1700 further comprises a plurality of spine routers 1100 as described above. The ingress processing apparatus 100 is communicatively coupled to at least one of the leaf routers 900 to inject a multicast packet into a hierarchical fabric formed by the communicative coupling of the plurality of leaf routers 900 and the plurality of spine routers 1100

Further details and aspects are mentioned in connection with the examples described above. The example shown in FIG. 17 may include one or more optional additional features corresponding to one or more aspects mentioned in connection with the proposed concept or one or more examples described above (e.g., FIGS. 1-16).

In the following, some examples of the proposed concept are presented:

An example (e.g., example 1) relates to an apparatus comprising a first data path configured to process a read or write network transaction request, and a second data path, parallel to the first data path, configured to process a multicast network transaction request, the second data path comprising a multicast destination circuitry configured to generate a destination bit-vector based on the multicast network transaction request, and packetization circuitry configured to form a multicast packet comprising the destination bit-vector for injection into the hierarchical fabric.

Another example (e.g., example 2) relates to a previous example (e.g., example 1) or to any other example, further comprising that the multicast destination circuitry comprises a table structure indexed by a multicast operation identifier included in the multicast request, and wherein each entry in the table structure comprises permission information.

Another example (e.g., example 3) relates to a previous example (e.g., example 2) or to any other example, further comprising that the second data path is further configured to authorize the multicast network transaction request based on a requester identity and the permission information from the multicast destination table, wherein said authorization is performed prior to the programmable multicast destination table producing the destination bit-vector.

Another example (e.g., example 4) relates to a previous example (e.g., one of the examples 1 to 3) or to any other example, further comprising that the first data path comprises an address translation table and a route table, and wherein the second data path bypasses the address translation table and the route table.

Another example (e.g., example 5) relates to a previous example (e.g., one of the examples 1 to 4) or to any other example, further comprising that the multicast destination circuitry is programmable via configuration register writes.

Another example (e.g., example 6) relates to a previous example (e.g., one of the examples 1 to 5) or to any other example, further comprising that the packetization circuitry is implemented as at least one of combinational logic or a finite state machine.

Another example (e.g., example 7) relates to a previous example (e.g., one of the examples 1 to 6) or to any other example, further comprising arbitration circuitry configured to select between an output of the first data path and an output of the second data path for injection into the hierarchical fabric.

Another example (e.g., example 8) relates to a previous example (e.g., one of the examples 1 to 7) or to any other example, further comprising that the hierarchical fabric comprises a plurality of leaf routers and a plurality of spine routers, and the apparatus and the hierarchical fabric are implemented on a single semiconductor die.

Another example (e.g., example 9) relates to a previous example (e.g., one of the examples 1 to 8) or to any other example, further comprising that the destination bit-vector is configured to identify, as a target endpoint port, an egress port of the hierarchical fabric, the egress port being coupled to an egress translation block configured to encode information from the multicast packet into a transaction for a standard interface protocol.

An example (e.g., example 10) relates to a network router, comprising a plurality of bidirectional ports configured for connection to local endpoint interfaces and at least one higher-tier router, a crossbar configured to selectively connect the ports, and a multicast circuitry coupled to the ports and the crossbar, the multicast circuitry being configured to receive a packet including a multicast destination bit-vector from a source port of the plurality of ports, control the crossbar to replicate the packet to one or more of the local endpoint interfaces based on the destination bit-vector, generate a masked bit-vector based on the destination bit-vector that indicates one or more non-local destinations reachable only via the at least one higher-tier router, and forward the packet with the masked bit-vector toward the at least one higher-tier router only when the masked bit-vector is non-zero.

Another example (e.g., example 11) relates to a previous example (e.g., example 10) or to any other example, further comprising that the destination bit-vector comprises a first portion of bits corresponding to the local endpoint interfaces and a second portion of bits corresponding to the non-local destinations, and wherein the multicast circuitry is configured to control the crossbar to replicate the packet based on the first portion of the destination bit-vector, and generate the masked bit-vector based on the second portion of the destination bit-vector.

Another example (e.g., example 12) relates to a previous example (e.g., example 11) or to any other example, further comprising that generating the masked bit-vector comprises clearing the first portion of bits in the destination bit-vector.

Another example (e.g., example 13) relates to a previous example (e.g., one of the examples 10 to 12) or to any other example, further comprising that the multicast circuitry is further configured to prevent the crossbar from forwarding the packet back to the source port from which the packet was received.

Another example (e.g., example 14) relates to a previous example (e.g., one of the examples 10 to 13) or to any other example, further comprising that the multicast circuitry is implemented as at least one of combinational logic or a finite state machine.

Another example (e.g., example 15) relates to a previous example (e.g., one of the examples 10 to 14) or to any other example, further comprising that the multicast circuitry is further configured to select a target higher-tier router from the at least one higher-tier routers based on a mapping between an identifier of the network router and the at least one higher-tier router.

Another example (e.g., example 16) relates to a previous example (e.g., example 15) or to any other example, further comprising that the multicast circuitry is further configured to implement adaptive routing by selecting an alternative higher-tier router if the target higher-tier router has no available credits.

Another example (e.g., example 17) relates to a previous example (e.g., one of the examples 10 to 16) or to any other example, further comprising that the multicast circuitry is further configured to, upon receiving a second packet including a second, pre-masked destination bit-vector from a higher-tier router, control the crossbar to replicate the second packet only to one or more of the local endpoint interfaces indicated by the second destination bit-vector.

Another example (e.g., example 18) relates to a previous example (e.g., one of the examples 10 to 17) or to any other example, further comprising that the router is an on-die network router for a hierarchical fabric, and wherein the hierarchical fabric is a fat-tree topology and the network router is a leaf router of the fat-tree topology and the at least one higher-tier router is a spine router of the fat-tree topology.

An example (e.g., example 19) relates to a network router, comprising a plurality of bidirectional ports configured for connection to a plurality of lower-tier routers, a crossbar configured to selectively connect the ports, and a multicast circuitry coupled to the ports and the crossbar, the multicast circuitry being configured to receive a packet including a first multicast destination bit-vector from a source lower-tier router, determine, based on the first destination bit-vector, a set of target lower-tier routers to receive the packet, for each of the target lower-tier routers, generate a respective second, masked destination bit-vector, replicate the packet, and control the crossbar to transmit a replicated packet with the respective second destination bit-vector to each of the target lower-tier routers.

Another example (e.g., example 20) relates to a previous example (e.g., example 19) or to any other example, further comprising that generating the respective second, masked destination bit-vector for each of the target lower-tier routers comprises masking the first destination bit-vector to preserve only a portion of bits corresponding to endpoint interfaces of that target lower-tier router.

Another example (e.g., example 21) relates to a previous example (e.g., one of the examples 19 or 20) or to any other example, further comprising that the multicast circuitry is configured to transmit the replicated packets to the target lower-tier routers in parallel or serially.

Another example (e.g., example 22) relates to a previous example (e.g., one of the examples 19 to 21) or to any other example, further comprising that the multicast circuitry is implemented as at least one of combinational logic or a finite state machine.

Another example (e.g., example 23) relates to a previous example (e.g., one of the examples 19 to 22) or to any other example, further comprising that transmission of the replicated packets is based on available flow-control signals from the target lower-tier routers.

Another example (e.g., example 24) relates to a previous example (e.g., one of the examples 19 to 23) or to any other example, further comprising that the router is an on-die network router for a hierarchical fabric, and wherein the hierarchical fabric is a fat-tree topology, the network router is a spine router of the fat-tree topology, and the plurality of lower-tier routers are leaf routers of the fat-tree topology.

An example (e.g., example 25) relates to a network-on-chip system, comprising an ingress processing apparatus according to any one of examples 1 to 9, a plurality of leaf routers according to any one of examples 10 to 18, and a plurality of spine routers according to any one of examples 19 to 24, wherein the ingress processing apparatus is communicatively coupled to at least one of the leaf routers to inject a multicast packet into a hierarchical fabric formed by the communicative coupling of the plurality of leaf routers and the plurality of spine routers.

An example (e.g., example 26) relates to a method comprising processing a read or write network transaction request via a first data path, processing, via a second data path parallel to the first data path, a multicast network transaction request, the processing via the second data path comprising generating a destination bit-vector based on the multicast network transaction request, and forming a multicast packet comprising the destination bit-vector for injection into a hierarchical fabric.

Another example (e.g., example 27) relates to a previous example (e.g., example 26) or to any other example, further comprising that generating the destination bit-vector comprises accessing a table structure indexed by a multicast operation identifier included in the multicast network transaction request, and wherein each entry in the table structure comprises permission information.

Another example (e.g., example 28) relates to a previous example (e.g., example 27) or to any other example, further comprising authorizing the multicast network transaction request based on a requester identity and the permission information from the table structure, wherein said authorizing is performed prior to generating the destination bit-vector.

Another example (e.g., example 29) relates to a previous example (e.g., one of the examples 26 to 28) or to any other example, further comprising that processing the read or write network transaction request comprises using an address translation table and a route table, and wherein processing the multicast network transaction request bypasses the address translation table and the route table. 30 The method of any one of examples 26 to 29, wherein generating the destination bit-vector comprises accessing multicast destination circuitry that is programmable via configuration register writes.

Another example (e.g., example 31) relates to a previous example (e.g., one of the examples 26 to 30) or to any other example, further comprising that forming the multicast packet is performed using at least one of combinational logic or a finite state machine.

Another example (e.g., example 32) relates to a previous example (e.g., one of the examples 26 to 31) or to any other example, further comprising selecting, via arbitration, between an output of the first data path and an output of the second data path for injection into the hierarchical fabric.

Another example (e.g., example 33) relates to a previous example (e.g., one of the examples 26 to 32) or to any other example, further comprising that the hierarchical fabric comprises a plurality of leaf routers and a plurality of spine routers, and wherein the method is performed on a single semiconductor die.

Another example (e.g., example 34) relates to a previous example (e.g., one of the examples 26 to 33) or to any other example, further comprising that the destination bit-vector identifies, as a target endpoint port, an egress port of the hierarchical fabric, the method further comprising encoding, via an egress translation block coupled to the egress port, information from the multicast packet into a transaction for a standard interface protocol.

An example (e.g., example 35) relates to a method for network routing, comprising receiving a packet including a multicast destination bit-vector from a source port of a plurality of bidirectional ports, controlling a crossbar to replicate the packet to one or more local endpoint interfaces based on the destination bit-vector, generating a masked bit-vector based on the destination bit-vector that indicates one or more non-local destinations reachable only via at least one higher-tier router, and forwarding the packet with the masked bit-vector toward the at least one higher-tier router only when the masked bit-vector is non-zero.

Another example (e.g., example 36) relates to a previous example (e.g., example 35) or to any other example, further comprising that the destination bit-vector comprises a first portion of bits corresponding to the local endpoint interfaces and a second portion of bits corresponding to the non-local destinations, and wherein the method comprises controlling the crossbar to replicate the packet based on the first portion of the destination bit-vector, and generating the masked bit-vector based on the second portion of the destination bit-vector.

Another example (e.g., example 37) relates to a previous example (e.g., example 36) or to any other example, further comprising that generating the masked bit-vector comprises clearing the first portion of bits in the destination bit-vector.

Another example (e.g., example 38) relates to a previous example (e.g., one of the examples 35 to 37) or to any other example, further comprising preventing the crossbar from forwarding the packet back to the source port from which the packet was received.

Another example (e.g., example 39) relates to a previous example (e.g., one of the examples 35 to 38) or to any other example, further comprising that controlling the crossbar and generating the masked bit-vector are performed using at least one of combinational logic or a finite state machine.

Another example (e.g., example 40) relates to a previous example (e.g., one of the examples 35 to 39) or to any other example, further comprising selecting a target higher-tier router from the at least one higher-tier router based on a mapping between an identifier of a network router and the at least one higher-tier router.

Another example (e.g., example 41) relates to a previous example (e.g., example 40) or to any other example, further comprising implementing adaptive routing by selecting an alternative higher-tier router if the target higher-tier router has no available credits.

Another example (e.g., example 42) relates to a previous example (e.g., one of the examples 35 to 41) or to any other example, further comprising upon receiving a second packet including a second, pre-masked destination bit-vector from a higher-tier router, controlling the crossbar to replicate the second packet only to one or more of the local endpoint interfaces indicated by the second destination bit-vector.

Another example (e.g., example 43) relates to a previous example (e.g., one of the examples 35 to 42) or to any other example, further comprising that the method is performed by a leaf router of a fat-tree topology hierarchical fabric, and wherein the at least one higher-tier router is a spine router of the fat-tree topology.

An example (e.g., example 44) relates to a method for network routing, comprising receiving a packet including a first multicast destination bit-vector from a source lower-tier router, determining, based on the first destination bit-vector, a set of target lower-tier routers to receive the packet, for each of the target lower-tier routers, generating a respective second, masked destination bit-vector, replicating the packet, and controlling a crossbar to transmit a replicated packet with the respective second destination bit-vector to each of the target lower-tier routers.

Another example (e.g., example 45) relates to a previous example (e.g., example 44) or to any other example, further comprising that generating the respective second, masked destination bit-vector for each of the target lower-tier routers comprises masking the first destination bit-vector to preserve only a portion of bits corresponding to endpoint interfaces of that target lower-tier router.

Another example (e.g., example 46) relates to a previous example (e.g., one of the examples 44 or 45) or to any other example, further comprising that transmitting the replicated packets to the target lower-tier routers is performed in parallel or serially.

Another example (e.g., example 47) relates to a previous example (e.g., one of the examples 44 to 46) or to any other example, further comprising that determining target routers, generating masked bit-vectors, and controlling the crossbar are performed using at least one of combinational logic or a finite state machine.

Another example (e.g., example 48) relates to a previous example (e.g., one of the examples 44 to 47) or to any other example, further comprising that transmitting the replicated packets is based on available flow-control signals from the target lower-tier routers.

Another example (e.g., example 49) relates to a previous example (e.g., one of the examples 44 to 48) or to any other example, further comprising that the method is performed by a spine router of a fat-tree topology hierarchical fabric, and wherein the plurality of lower-tier routers are leaf routers of the fat-tree topology.

Another example (e.g., example 50) relates to a computer program having a program code for performing the method of any one of examples 26 to 49 when the computer program is executed on a computer, a processor, or a programmable hardware component.

Another example (e.g., example 51) relates to a computer-readable medium including program code, when executed, to cause a machine to perform the method of any one of examples 26 to 49.

Another example (e.g., example 52) relates a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising:
a first data path configured to process a read or write network transaction request; and
a second data path, parallel to the first data path, configured to process a multicast network transaction request, the second data path comprising:
a multicast destination circuitry configured to generate a destination bit-vector based on the multicast network transaction request; and
packetization circuitry configured to form a multicast packet comprising the destination bit-vector for injection into the hierarchical fabric.

2. The apparatus of claim 1, wherein the multicast destination circuitry comprises a table structure indexed by a multicast operation identifier included in the multicast request, and wherein each entry in the table structure comprises permission information.

3. The apparatus of claim 2, wherein the second data path is further configured to authorize the multicast network transaction request based on a requester identity and the permission information from the multicast destination table, wherein said authorization is performed prior to the programmable multicast destination table producing the destination bit-vector.

4. The apparatus of claim 1, wherein the first data path comprises an address translation table and a route table, and wherein the second data path bypasses the address translation table and the route table.

5. The apparatus of claim 1, wherein the multicast destination circuitry is programmable via configuration register writes.

6. The apparatus of claim 1, wherein the packetization circuitry is implemented as at least one of: combinational logic or a finite state machine.

7. The apparatus of claim 1, further comprising arbitration circuitry configured to select between an output of the first data path and an output of the second data path for injection into the hierarchical fabric.

8. The apparatus of claim 1, wherein the hierarchical fabric comprises a plurality of leaf routers and a plurality of spine routers; and the apparatus and the hierarchical fabric are implemented on a single semiconductor die.

9. The apparatus of claim 1, wherein the destination bit-vector is configured to identify, as a target endpoint port, an egress port of the hierarchical fabric, the egress port being coupled to an egress translation block configured to encode information from the multicast packet into a transaction for a standard interface protocol.

10. A network router, comprising:
a plurality of bidirectional ports configured for connection to local endpoint interfaces and at least one higher-tier router;
a crossbar configured to selectively connect the ports; and
a multicast circuitry coupled to the ports and the crossbar, the multicast circuitry being configured to:
receive a packet including a multicast destination bit-vector from a source port of the plurality of ports;
control the crossbar to replicate the packet to one or more of the local endpoint interfaces based on the destination bit-vector;
generate a masked bit-vector based on the destination bit-vector that indicates one or more non-local destinations reachable only via the at least one higher-tier router; and
forward the packet with the masked bit-vector toward the at least one higher-tier router only when the masked bit-vector is non-zero.

11. The network router of claim 10, wherein the destination bit-vector comprises a first portion of bits corresponding to the local endpoint interfaces and a second portion of bits corresponding to the non-local destinations, and wherein the multicast circuitry is configured to control the crossbar to replicate the packet based on the first portion of the destination bit-vector; and
generate the masked bit-vector based on the second portion of the destination bit-vector.

12. The network router of claim 11, wherein generating the masked bit-vector comprises clearing the first portion of bits in the destination bit-vector.

13. The network router of claim 10, wherein the multicast circuitry is further configured to prevent the crossbar from forwarding the packet back to the source port from which the packet was received.

14. The network router of claim 10, wherein the multicast circuitry is implemented as at least one of combinational logic or a finite state machine.

15. The network router of claim 10, wherein the multicast circuitry is further configured to select a target higher-tier router from the at least one higher-tier routers based on a mapping between an identifier of the network router and the at least one higher-tier router.

16. The network router of claim 15, wherein the multicast circuitry is further configured to implement adaptive routing by selecting an alternative higher-tier router if the target higher-tier router has no available credits.

17. The network router of claim 10, wherein the multicast circuitry is further configured to, upon receiving a second packet including a second, pre-masked destination bit-vector from a higher-tier router, control the crossbar to replicate the second packet only to one or more of the local endpoint interfaces indicated by the second destination bit-vector.

18. A network router, comprising:
a plurality of bidirectional ports configured for connection to a plurality of lower-tier routers;
a crossbar configured to selectively connect the ports; and
a multicast circuitry coupled to the ports and the crossbar, the multicast circuitry being configured to:
receive a packet including a first multicast destination bit-vector from a source lower-tier router;
determine, based on the first destination bit-vector, a set of target lower-tier routers to receive the packet;
for each of the target lower-tier routers, generate a respective second, masked destination bit-vector;
replicate the packet; and
control the crossbar to transmit a replicated packet with the respective second destination bit-vector to each of the target lower-tier routers.

19. The network router of claim 18, wherein generating the respective second, masked destination bit-vector for each of the target lower-tier routers comprises masking the first destination bit-vector to preserve only a portion of bits corresponding to endpoint interfaces of that target lower-tier router.

20. The network router of claim 18, wherein the multicast circuitry is configured to transmit the replicated packets to the target lower-tier routers in parallel or serially.
